(19) United States
(12) Patent Application Publication
(10) Pub. No.: US 2019/0193956 A1
(43) Pub. Date: Jun. 27, 2019

(54) SYSTEM FOR DYNAMIC PALLET-BUILD

(71) Applicant: Walmart Apollo, LLC, Bentonville, AR (US)

(72) Inventors: Daniel Morland, Bentonville, AR (US); Esteban Fuentes, Bentonville, AR (US)

(21) Appl. No.: 16/179,699

(22) Filed: Nov. 2, 2018

Related U.S. Application Data
(60) Provisional application No. 62/609,067, filed on Dec. 21, 2017.

(51) Int. Cl. B65G 57/03; G06F 17/30; G05B 19/416

(52) U.S. Cl. CPC B65G 57/03; G06F 17/30979; B65G 2201/0267; G05B 2219/36508; G05B 19/416

(57) ABSTRACT

Examples provide a dynamic pallet-build system for generating pallet-build instructions in real-time during pallet-build. Pallet-build instructions, including an assigned location for a next item in an item placement sequence is output to a user. If the next item is placed in an incorrect location on the pallet, a temporary placement query requesting a temporary placement status of the incorrectly placed item is output to the user. If the placement is temporary, the assigned location of the next item in the item placement sequence is output. If the placement is permanent, a modified location of the next item in the original item placement sequence or an assigned location of the next item in a modified item placement sequence is output to the user. The dynamic pallet-build system dynamically outputs assigned locations for each item in the item placement sequence until pallet-build is complete.

### BACKGROUND

A pallet is a transport structure used for shipping goods. The more tightly and/or efficiently items are packed into each pallet, the fewer pallets are required. A pallet-build plan may assign items to locations within a pallet to improve pallet packing. However, pallet-build plans frequently require users to follow the plan without deviation. If a user building a pallet places an item in the wrong place on the pallet, it may change the dimensions of the remaining available space in the pallet to such a degree that the pallet-build plan is no longer valid. In other words, if an item is misplaced, all the remaining items which were to be packed in the pallet may no longer fit within the pallet. This results in inflexible pallet-build plans and/or creation of sub-optimal pallets.

### SUMMARY

Examples of the disclosure provide a system for customized pallet-build. The system includes a memory and at least one processor communicatively coupled to the memory. An interactive pallet-build component generates a set of per-pallet build instructions for creating a proposed pallet including a selected set of items based on item data. The set of per-pallet build instructions includes an item placement sequence and an assigned location for each item in the selected set of items. A verification component analyzes user input and sensor data received from a set of sensors associated with a pallet-build area. The verification component identifies item placement for each item in the selected set of items placed within a partially completed pallet. The verification component generates dynamic item location data for each item in the selected set of items placed on the partially completed pallet. The interactive pallet-build component dynamically modifies the item placement sequence. The interactive pallet-build component modifies a next assigned location of a next item to be placed on the partially completed pallet in the modified item placement sequence based on the dynamic item location data obtained from the verification component. The interactive pallet-build component optimizes pallet build in real-time as each item is placed. A communications interface component outputs the dynamically modified next assigned location of the next item in the item placement sequence to a user device associated with the user.

Other examples provide a computer-implemented method for customized pallet-build. An interactive pallet-build component generates a set of per-pallet build instructions for creating a proposed pallet including a selected set of items based on item data. The set of per-pallet build instructions comprising an item placement sequence and an assigned location for each item in the selected set of items. A verification component analyzes sensor data received from a set of sensors associated with a pallet-build area to identify item placement for each item placed within a partially completed pallet. The verification component generates dynamic item location data for each item from the selected set of items placed on the partially completed pallet. The interactive pallet-build component dynamically modifies the item placement sequence for a remaining set of items to be placed on the partially completed pallet based on the dynamic item location data. The interactive pallet-build component outputs a next assigned location of a next item in the dynamically modified item placement sequence to a user device associated with the user.

Still other examples provide one or more computer storage media, having computer-executable instructions for customized pallet-build that, when executed by a computer cause the computer to analyze sensor data received from a set of sensors associated with a pallet-build area to identify item placement for each item placed within a partially completed pallet; send a temporary placement query requesting a temporary placement status of an incorrectly placed item to the user device in response to detecting an item placed at an incorrect placement location; output an unmodified next assigned location of a next item in an item placement sequence to the user device associated with the user in response to receiving the temporary placement status of the incorrectly placed item; and output a dynamically modified next assigned location of the next item in the item placement sequence to the user device associated with the user in response to receiving a permanent placement status of the incorrectly placed item.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for generating dynamic pallet-build instructions.

FIG. 2 is an exemplary block diagram illustrating a dynamic pallet-build component.

FIG. 3 is an exemplary block diagram illustrating dynamic item location data.

FIG. 4 is an exemplary block diagram of a set of pallet-build criteria.

FIG. 5 is an exemplary block diagram of a pallet having a plurality of uniform layers.

FIG. 6 is an exemplary block diagram of a pallet having a plurality of non-uniform layers.

FIG. 7 is an exemplary block diagram of placement of items on a pallet in accordance with pallet layering rules.

FIG. 8 is an exemplary block diagram of a pallet having a plurality of items placed within a plurality of uniform layers.

FIG. 9 is an exemplary block diagram of a pallet having a plurality of items placed within a plurality of non-uniform layers.

FIG. 10 is an exemplary block diagram of an augmented reality pallet-build instructions.

FIG. 11 is an exemplary block diagram of an augmented reality dynamic pallet-build instructions for a next item in an item placement sequence.

FIG. 12 is an exemplary block diagram of an augmented reality display showing a partially completed pallet.

FIG. 13 is an exemplary block diagram of an augmented reality dynamic pallet-build instructions outputting a next assigned location for a next item in an item placement sequence.

FIG. 14 is an exemplary block diagram of an augmented reality dynamic pallet-build instructions outputting a next assigned location indicator for a next item in the item placement sequence for a partially completed pallet.

FIG. 15 is an exemplary block diagram of a pallet-build area including a partially build pallet.

FIG. 16 is an exemplary block diagram of a plurality of items associated with a pallet-build.

FIG. 17 is an exemplary block diagram of a customized warehouse layout generator.

FIG. 18 is an exemplary block diagram of a customized warehouse layout.

FIG. 19 is an exemplary table illustrating item dimensions.

FIG. 20 is an exemplary flow chart illustrating operation of the computing device to assign items to pallet layers in accordance with pallet layering rules.

FIG. 21 is an exemplary flow chart illustrating operation of the computing device to generate dynamic pallet-build instructions.

FIG. 22 is an exemplary flow chart illustrating operation of the computing device to generate a modified item location in response to an incorrectly placed item.

FIG. 23 is an exemplary flow chart illustrating operation of the computing device to generate item location data based on temporary placement status of items.

Corresponding reference characters indicate corresponding parts throughout the drawings.

### DETAILED DESCRIPTION

Referring to the figures, examples of the disclosure enable dynamic pallet-builds. In some examples, a dynamic pallet-build component generates dynamic pallet-build instructions for creating a proposed pallet which is updated in real-time in response to detection of an item placed in an incorrect location within a partially complete pallet. The dynamic pallet-build component generates updated instructions which compensate for misplaced items to pack a maximum number of items within each pallet while minimizing unused space within each pallet. This reduces the number of pallets required for moving items from one location to another while simultaneously reducing expenses associated with transport of these items.

In other examples, the dynamic pallet-build component outputs the dynamically modified pallet-build instructions to one or more users building the pallet in real-time to reduce the amount of time required to build each pallet and improve user efficiency during the pallet-build process.

The dynamic pallet-build component in other examples detects errors in real-time and outputs instructions to one or more users for correcting the error and/or compensating for the error. These instructions further reduce errors during the pallet-build by detecting errors as they occur and outputting instructions for correcting the error. The dynamic pallet-build component also outputs instructions changing the pallet-build plan in real-time to compensate for errors occurring during the pallet-build when correction is not possible or instructions for correcting one or more errors is not implemented. This reduces unused space within pallets and improves pallet-build efficiency.

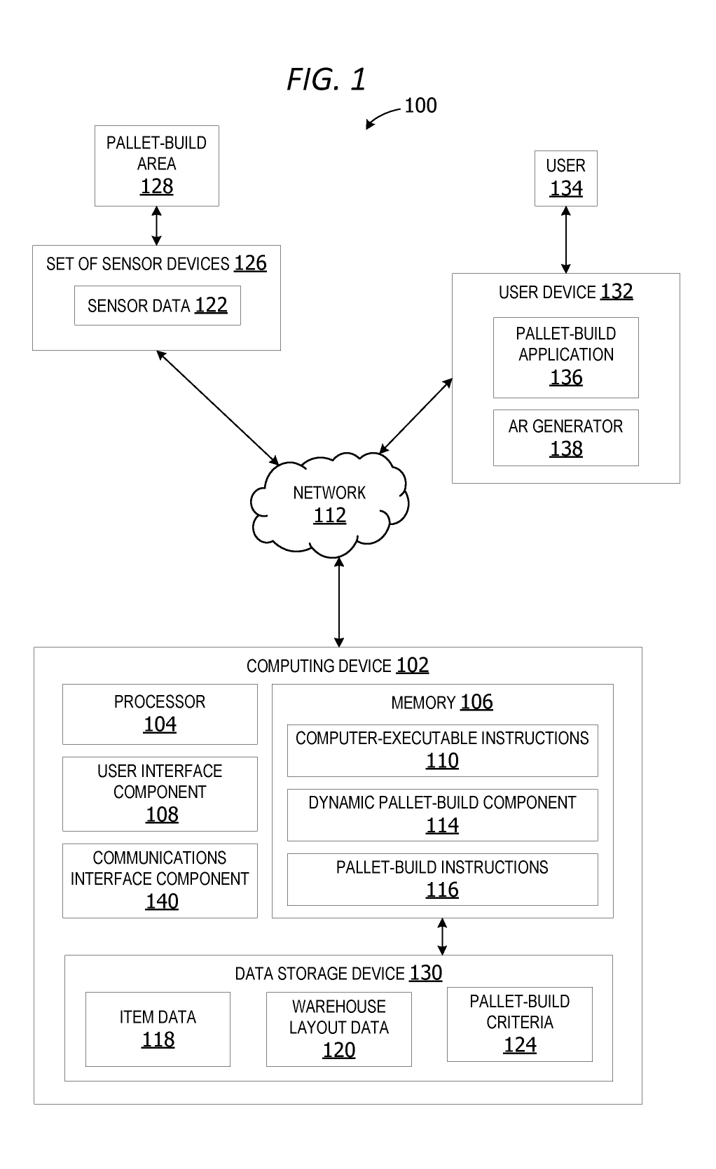

Referring again to FIG. 1, an exemplary block diagram illustrates a system 100 for generating dynamic pallet-build instructions. In the example of FIG. 1, the computing device 102 represents any device executing computer-executable instructions (e.g., as application programs, operating system functionality, or both) to implement the operations and functionality associated with the computing device 102. The computing device 102 may include a mobile computing device or any other portable device. In some examples, the mobile computing device includes a mobile telephone, laptop, tablet, computing pad, netbook, gaming device, and/or portable media player. The computing device 102 may also include less-portable devices such as server, a desktop personal computer, kiosk, and/or tabletop device. Additionally, the computing device 102 may represent a group of processing units or other computing devices.

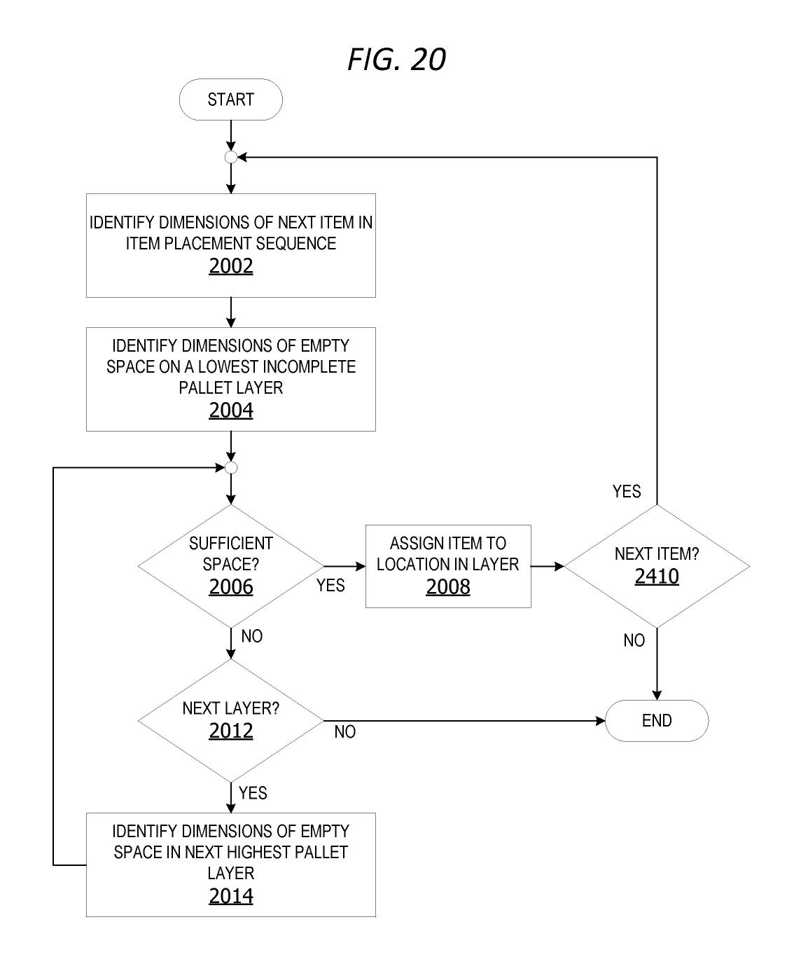

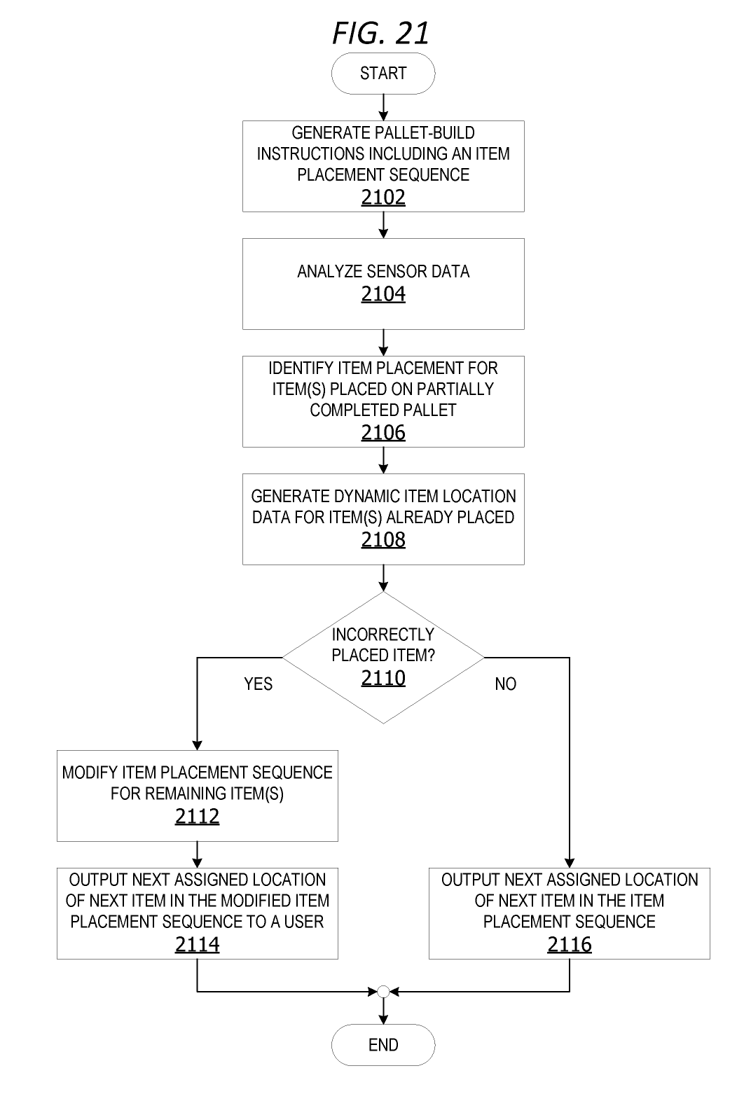

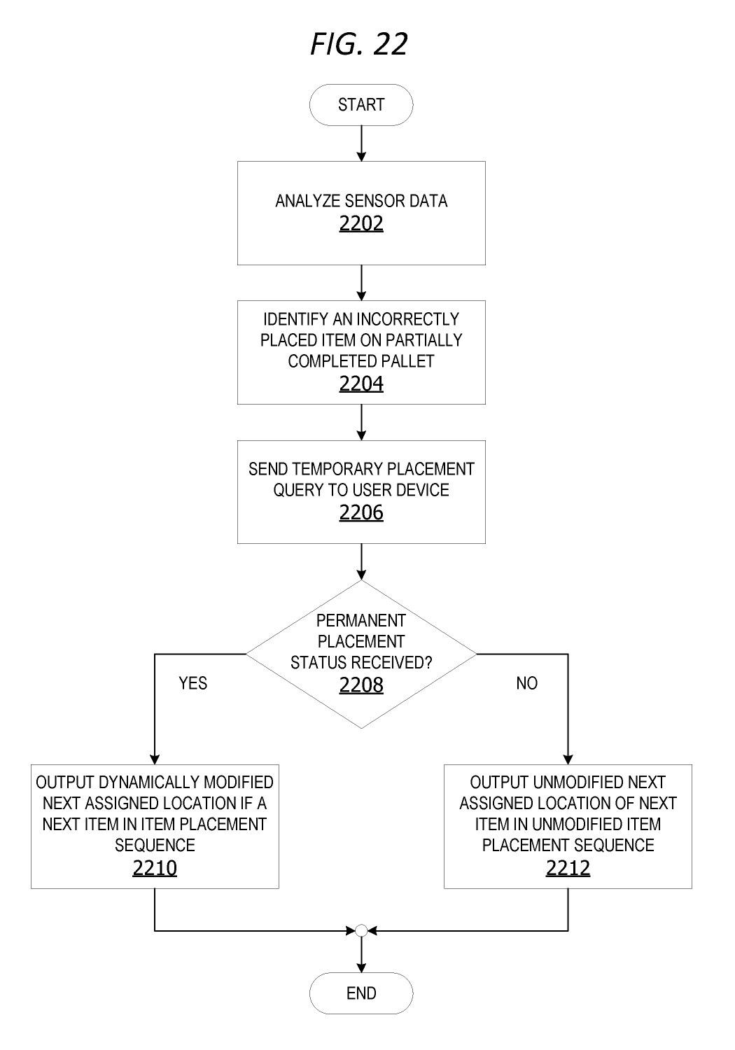

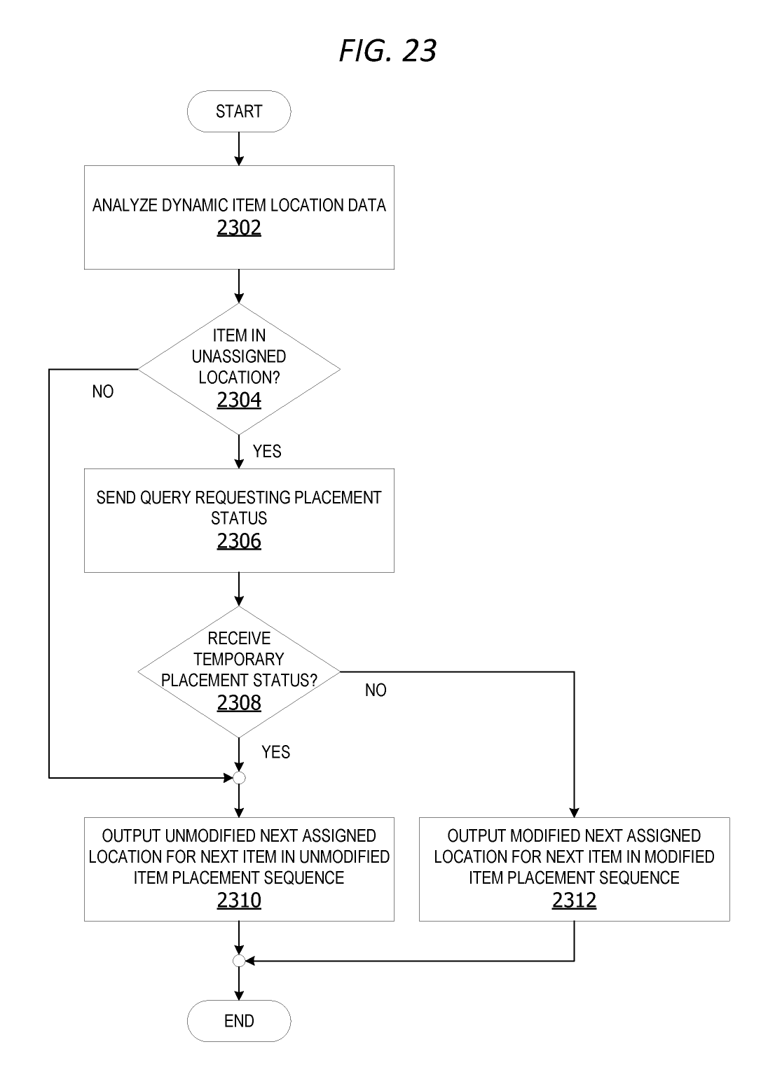

In some examples, the computing device 102 has at least one processor 104, a memory 106, and at least one user interface component 108. The processor 104 includes any quantity of processing units and is programmed to execute computer-executable instructions 110. The computer-executable instructions 110 may be performed by the processor 104 or by multiple processors within the computing device 102 or performed by a processor external to the computing device 102. In some examples, the processor 104 is programmed to execute computer-executable instructions 110 such as those illustrated in the figures (e.g., FIG. 20, FIG. 21, FIG. 22, and FIG. 23).

The computing device 102 further has one or more computer readable media, such as the memory 106. The memory 106 includes any quantity of media associated with or accessible by the computing device 102. The memory 106 may be internal to the computing device 102 (as shown in FIG. 1), external to the computing device (not shown), or both (not shown). In some examples, the memory 106 includes read-only memory and/or memory wired into an analog computing device.

The memory 106 stores data, such as one or more applications. The applications, when executed by the processor 104, operate to perform functionality on the computing device 102. The applications may communicate with counterpart applications or services, such as the pallet-build application 136 running on the user device 132 or web services accessible via a network 112. For example, the applications may represent downloaded client-side applications that correspond to server-side services executing in a cloud.

The network 112 is implemented by one or more physical network components, such as, but without limitation, routers, switches, network interface cards (NICs), and other network devices. The network 112 may be any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 may be a local or private LAN.

The memory 106 further stores one or more computer-executable components. Exemplary components include a dynamic pallet-build component 114 that, when executed by the processor 104 of the computing device 102, causes the processor 104 to generate a set of pallet-build instructions 116 for creating a proposed pallet. The set of pallet-build instructions 116 are generated by the dynamic pallet-build component 114 based on an analysis of item data 118, warehouse layout data 120, and/or sensor data 122 using pallet-build criteria 124.

The item data 118 is data describing one or more items in a set of items to be included within one or more proposed pallets. The item data 118 includes item dimensions. The item dimensions include the height, length, and width of an item. The item dimensions may also include the height, length, and width of a case of the items. A case is a box or other transport package containing two or more instances of the item. For example, a single box of shoes includes a single pair of shoes, a left shoe and a right shoe. A case of shoes may include a dozen boxes of shoes having one pair of shoes in each box for a total of twelve pairs of shoes in the case.

In other examples, the item data 118 includes an item identifier (ID), an item weight, item shape, color, variety, size, units per item, and/or item packaging type. The item weight may include a weight of a single item and/or a weight of a case of the items. The item shape identifies the shape of the item. The shape may be a sphere, a cube, a cylinder, an irregular shaped item, and/or any other type of item.

The warehouse layout data 120 is data describing a layout of a warehouse storing the one or more items. The warehouse layout data 120 in some examples includes an order or layout of items in an order-fill line associated with a pallet-build area. The items in the order-fill line are placed in a sequence that is the same or similar to the sequence in which the items will be placed on pallets. In other words, large or heavy items which are typically placed on the bottom layer of a pallet are typically placed at the beginning of an order-fill line in the warehouse layout. Items which are fragile or required to be placed on the top of a pallet are typically placed at the end or near the end of the order-fill line to accommodate the order-fillers.

The sensor data 122 is data generated by one or more sensor devices in a set of sensor devices 126 associated with a pallet-build area 128. The set of sensor devices 126 may include one or more image capture devices, such as cameras. The set of sensor devices 126 may also include radio frequency identifier (RFID) tag readers, beacon receivers, barcode readers, infrared sensors, or any other type of sensor devices for generating sensor data 122.

The sensor data 122 includes any type of sensor data generated by a sensor device. The sensor data 122 may include image data, infrared sensor data, barcode data, RFID tag data, or any other type of sensor data for identifying an item, identifying a location of an item, and/or identifying an orientation of an item placed on a pallet.

The pallet-build area 128 is an area associated with one or more users building or creating one or more pallets in accordance with the pallet-build instructions 116. The pallet-build area 128 in some examples includes a plurality of items to be packed into a set of one or more proposed pallets. A proposed pallet is a pallet which has not been built or has been partially built but incomplete.

The pallet-build criteria 124 is a set of one or more per-item rules associated with building pallets. The pallet-build criteria 124 in some examples includes pallet dimension guidelines, pallet layer guidelines, stacking criteria, item placement sequencing rules, layering rules, item quantity rules, and/or thresholds associated with building pallets.

The pallet-build criteria 124 in some examples include a sequence in which items are order-filled, the number of items to be placed on a given pallet, an order/sequence in which items are order-filled, stacking criteria for certain items. For example, stacking criteria may specify that no other items may be stacked on top of eggs except other eggs. In another example, stacking criteria for eggs may specify that only napkins or eggs may be stacked on top of eggs.

The pallet-build criteria 124 may also include user-defined settings to define total dimensions of a given pallet. The user-defined pallet dimensions include a length, width, and height of the given pallet. The pallet dimensions may be specified in inches, centimeters, or any other unit of measurement.

In some examples, the set of pallet-build instructions 116 includes an item placement sequence, an identification of a next item to be placed on a partially completed pallet, and dynamic item location data for the next item to be placed on the partially completed pallet. The dynamic pallet-build component 114 sends the set of pallet-build instructions 116 to a user device 132 associated with user 134 building one or more pallets in the pallet-build area 128.

The user device 132 in some examples is a mobile computing device or any other portable device. In some examples, the mobile computing device includes a mobile telephone, laptop, tablet, computing pad, netbook, gaming device, and/or portable media player. In still other examples, the user device 132 is an augmented reality (AR) device for generating an AR image. An AR image is a real-world image having one or more computer-generated elements superimposed over the real-world image as an overlay. In other words, an AR image is an image including both real-world elements and virtual/computer-generated elements. In this non-limiting example, the user device 132 generates AR images including real-world elements associated with the pallet-build area, and more specifically, with one or more partially completed pallets associated with the user 134.

The user device 132 in some examples is an AR device including an AR generator 138 for generating the AR image. The AR device may be implemented as an AR headset or other wearable device for generating AR images within a field-of-view (FOV) of the user 134. The AR device in other examples may include a hand-held or other portable device for generating AR images associated with the pallet-build area 128.

The system 100 may optionally include a data storage device 130 for storing data, such as, but not limited to, the item data 118, the warehouse layout data 120, the sensor data 122, and/or the pallet-build criteria 124. The data storage device 130 may include a set of one or more data storage devices storing data. The data storage device 130 may include one or more types of data storage devices, such as, for example, one or more rotating disks drives, one or more solid state drives (SSDs), and/or any other type of data storage device. The data storage device 130 in some non-limiting examples includes a redundant array of independent disks (RAID) array. In other examples, the data storage device 130 includes a database, file system, or other data structure.

The system 100 may optionally also include a communications interface component 140. In some examples, the communications interface component 140 includes a network interface card and/or computer-executable instructions (e.g., a driver) for operating the network interface card. Communication between the computing device 102 and other devices may occur using any protocol or mechanism over any wired or wireless connection. In some examples, the communications interface component 140 is operable with short range communication technologies such as by using near-field communication (NFC) tags.

In some examples, the user interface component 108 includes a graphics card for displaying data to the user and receiving data from the user. The user interface component 108 may also include computer-executable instructions (e.g., a driver) for operating the graphics card. Further, the user interface component 108 may include a display (e.g., a touch screen display or natural user interface) and/or computer-executable instructions (e.g., a driver) for operating the display. The user interface component 108 may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device 102 in a particular way.

In some examples, dynamic pallet-build component 114 calculates the item placement sequence specifying an order in which each item should be placed on the pallet. For example, if a set of four items are to be placed on the pallet, the item placement sequence may specify that an item A be placed on the pallet first, an item D be placed on the pallet second, an item C be placed on the pallet third, and an item B be placed on the pallet last. The dynamic pallet-build component 114 identifies a next item in the item placement sequence due to be placed on the pallet. The dynamic pallet-build component 114 calculates an assigned location for the next item to be placed on the pallet and outputs the assigned location to the pallet-build application 136 running on the user device 132.

The pallet-build application 136 outputs an identification of the next item to be placed on the pallet and the assigned location for the next item on the pallet relative to the partially completed pallet and any items already placed on the pallet. When the item is correctly placed at the assigned location, the pallet-build application 136 displays an identification of the next item in the item placement sequence to be placed on the pallet and the assigned location for this next item. This process continues until the pallet-build is complete.

The assigned location may be displayed by the pallet-build application 136 in a 3-D format via an AR display generated by the AR generator 138. The user views a representation of the next item and the assigned location of the next item in the AR display. If the user places the next item in the wrong place on the pallet, the AR image generated by the AR generator 138 changes to indicate incorrect placement of the item. This may occur by changing a color of the item, highlighting the item, adding an arrow or other indicator identifying the incorrect placement of the item.

In some examples, the user 134 may interact with the pallet-build application 136 to indicate whether an incorrectly placed item has been placed in a temporary location or a permanent location. If the location is temporary, the dynamic pallet-build component 114 continues outputting the next assigned locations for the next item in the item placement sequence until the user 134 moves the incorrectly placed item from the temporary location to the correct permanent location. If the user 134 selects an icon or otherwise provides input indicating the incorrect location of the item is permanent, the dynamic pallet-build component 114 modifies the item placement sequence and/or the assigned location(s) of one or more items to compensate for the unplanned/incorrect placement of the item.

The dynamic pallet-build component 114 in some examples calculates the assigned location for the next item to be placed on the pallet in a pallet-build by using one or more rules in the pallet-build criteria 124 in real-time. The dynamic pallet-build component 114 retrieves the pallet dimensions, the number of layers, the layer dimensions, and item dimensions for the set of items assigned to the given pallet. The user defines the number of layers and/or layer dimensions in some examples. In other examples, the dynamic pallet-build component 114 defines the number of layers and dimensions of each layer on the pallet. These layers determine how the system calculates the area in which to fill the pallet.

The dynamic pallet-build component 114 pulls item dimensions in item placement sequence and quantity of the order-fill. The dynamic pallet-build component 114 assigns items to an assigned location within the pallet beginning with the bottom-most layer while minimizing the unused space within each layer. The items are assigned to the pallet in a lowest layer first moving up. The dynamic pallet-build component 114 utilizes the defined item stack rules to turn the items in all potential orientations (directions), checking for the least amount of space used within each layer. Once an item no longer will fit into the current layer, the dynamic pallet-build component 114 moves to the next layer up and begins calculating possible locations for the next item in the next highest layer while continuing to try and fill the previous layer with up-coming items which may be smaller.

In other examples, upon creating the optimal pallet building map for each pallet, the dynamic pallet-build component 114 provides the pallet-build instructions 116 to the user 134 via a selected user interface, such as the user interface component 108 or via a user interface associated with the user device 132. The user interface allows the user 134 to change the position/location of an item on the pallet to improve volumetric efficiency.

The user device 132 in some examples includes smart glasses that use the AR generator 138 to project the 3-D image of the pallet-build instructions for the user to view. In some examples, the user device 132 provides a heads-up display (HUD) screen for outputting the pallet-build instructions 116. In other examples, the user device 132 is implemented as a smart tablet that uses AR technology to project a 3-D image for the user 134 to view the planned pallet builds.

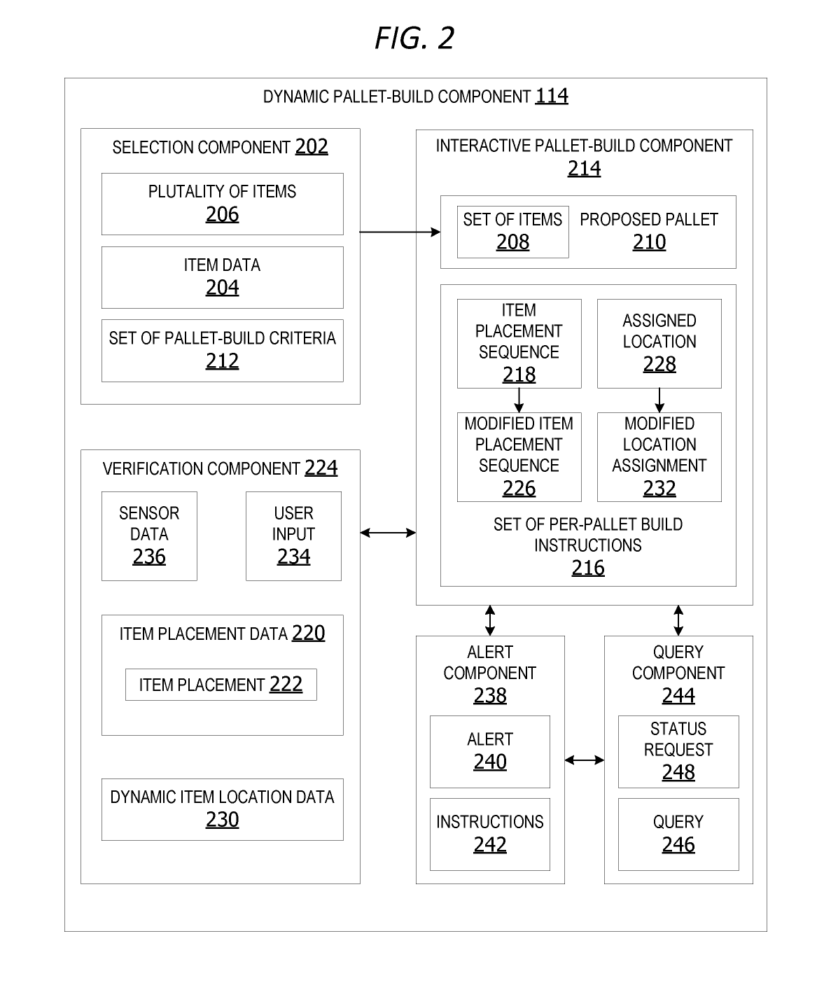

FIG. 2 is an exemplary block diagram illustrating a dynamic pallet-build component 114. In some examples, the dynamic pallet-build component 114 includes a selection component 202. The selection component 202 analyzes item data 204 associated with a plurality of items 206 to select a set of items 208 to be included with a proposed pallet 210. The selection component 202 in some examples analyzes the item data 204 using a set of pallet-build criteria 212, such as, but not limited to, the pallet-build criteria 124 in FIG. 1.

In other examples, the selection component 202 analyzes the item data 204 and warehouse layout data using the set of pallet-build criteria 212 to identify items to be included in each proposed pallet in a plurality of proposed pallets. The warehouse layout data is data describing a location of each item stored in a warehouse, such as the warehouse layout data 120 in FIG. 1.

In one non-limiting example, the selection component 202 selects a first set of items from the plurality of items 206 for inclusion within a first proposed pallet and selects a second set of items from the plurality of items for inclusion within a second proposed pallet based on the item data, proposed pallet dimensions, a set of item stacking criteria included within the set of pallet-build criteria 212, and the warehouse layout data.

An interactive pallet-build component 214 generates a set of per-pallet build instructions 216 for creating the proposed pallet 210 including the selected set of items 208. The set of per-pallet build instructions 216 includes instructions, such as, but not limited to, the pallet-build instructions 116 in FIG. 1.

The set of per-pallet build instructions 216 is a set of dynamic pallet-build instructions updated in real-time in response to placement of each item in the set of items into a partially complete pallet. In other words, the interactive pallet-build component identifies an actual placement or location of each item as it is placed onto a partial pallet and modifies the set of per-pallet-build instructions 216 in response to the actual placement of each item on the pallet as the pallet is being built.

The set of per-pallet build instructions 216 in some examples includes an item placement sequence 218. The item placement sequence 218 provides a sequence in which items are to be placed onto the pallet being built. For example, if three items (item A, item B, and item C) are to be packed into a single pallet, the item placement sequence may specify that item B should be placed on the pallet first, item A should be placed on the pallet second, and item C should be placed on the pallet last.

In some example, the interactive pallet-build component 214 monitors placement of items on a partially built pallet for compliance with the pallet-build instructions. The interactive pallet-build component 214 analyzes sensor data generated by one or more cameras or other sensors associated with the pallet, such as the set of sensor devices 126 in FIG. 1.

The interactive pallet-build component 214 monitors placement of items to determine the location of each item on the pallet. The interactive pallet-build component 214 in these examples analyzes item placement data 220 generated by a verification component 224 to identify item placement 222 of each item on the partially complete pallet and/or dynamic item location data 230. The item placement 222 identifies placement of an item on a partially completed pallet. The dynamic item location data 230 identifies a three-dimensional location and orientation of an item placed on the partially completed pallet.

The interactive pallet-build component 214 generates a modified item placement sequence 226 in response to item placement data 220 and/or dynamic item location data 230 indicating that one or more items have been placed on the pallet at an incorrect/un-assigned location and/or an incorrect orientation of the item. In other words, an item may be placed at the wrong location in the pallet or the item may be placed in the correction location but be oriented incorrectly such that the item occupies space assigned in whole or in part to another item. In this case, the pre-existing item placement sequence 218 may no longer represent an optimal sequence for placement of items on the pallet.

In these examples, the interactive pallet-build component 214 generates the modified item placement sequence 226 to compensate for the incorrectly placed item(s). The modified item placement sequence 226 alters or modifies the sequence of item placement on the pallet to compensate for the one or more items placed at an incorrect location or orientation on the partially completed pallet.

For example, if the item placement sequence 218 instructs a user to place an item A on a pallet first, place an item B on the pallet second, an item C on the pallet third, and an item D on the pallet fourth, but the item placement data 220 indicates item C is placed on the pallet first, the interactive pallet-build component 214 may generate the modified item placement sequence 226 changing the sequence to place item A on the pallet second and item D on the pallet third, and item B on the pallet last to compensate for the incorrectly placed item C.

The set of per-pallet build instructions 216 in other examples includes an assigned location 228 for each item in the selected set of items 208. The assigned location 228 identifies a three-dimensional location for an item in a proposed pallet. The assigned location 228 in some examples includes a pallet layer identification, a length identifier, a height identifier, a width identifier, and an orientation for an item being placed onto a pallet. The assigned location 228 includes a location where each item assigned to be placed on the proposed pallet 210 should be placed in accordance with the set of per-pallet build instructions 216. In other words, the assigned location 228 includes a three-dimensional location in a pallet assigned to a given item and an orientation of the item.

The interactive pallet-build component 214 generates a modified location assignment 232 in response to item placement data 220 and/or dynamic item location data 230 indicating that one or more items have been placed on the pallet at an incorrect location and/or an incorrect orientation. In this case, the pre-existing item assigned location 228 may no longer represent an optimal location and/or orientation for remaining items in the set of items 208 that have not yet been placed on the partially built pallet. In these examples, the interactive pallet-build component 214 generates the modified location assignment 232 to compensate for the incorrectly placed item(s). The modified location assignment 232 alters or modifies the location and/or the orientation assigned to one or more items which have not yet been placed on the partially completed pallet.

The verification component 224 in some examples analyzes user input 234 and sensor data 236 received from a set of sensor devices associated with a pallet-build area, such as, but not limited to, the set of sensor devices 126 associated with the pallet-build area 128 in FIG. 1. The user input 234 may include user input data indicating a permanent placement of an item and/or a temporary placement of an item that will be moved to a different permanent location within the pallet. The user input 234 in some examples may optionally include user input data identifying an item placed incorrectly on the pallet.

The verification component 224 identifies item placement 222 for each item in the selected set of items 208 placed within a partially completed pallet. The verification component 224 generates dynamic item location data 230 for each item in the selected set of items 208 placed on the partially completed pallet.

In some examples, an alert component 238 outputs an alert 240 to a user device associated with a user, such as the user device 132 in FIG. 1. The alert in some examples identifies an item incorrectly placed on a partially built pallet.

In other examples, the alert component 238 provides instructions 242 for moving an incorrectly placed item to a correct assigned placement location on the partially built pallet and/or instructions 242 to move the incorrectly placed item to a modified location assignment. The modified location assignment is an updated or different assigned location.

A query component 244 outputs a query 246 to the user device via the communications interface component. The query 246 requests a temporary placement status of an incorrectly placed item. The interactive pallet-build component 214 outputs an unmodified next assigned placement location for a next item in the item placement sequence in response to receiving a status request 248 indicating an incorrectly placed item has a temporary placement status. The temporary placement status indicates the incorrectly placed item will be moved to a different location prior to completion of the pallet build. In other words, the user may indicate an item or box is placed in a temporary location on the pallet and will be moved to a permanent location later via a temporary placement status indicator.

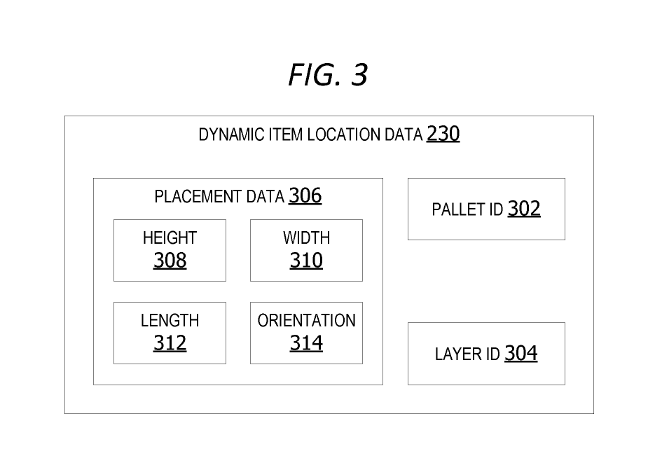

FIG. 3 is an exemplary block diagram illustrating dynamic item location data 230. The dynamic item location data 230 optionally includes a pallet identifier (ID) 302 identifying a given pallet in a plurality of two or more pallets.

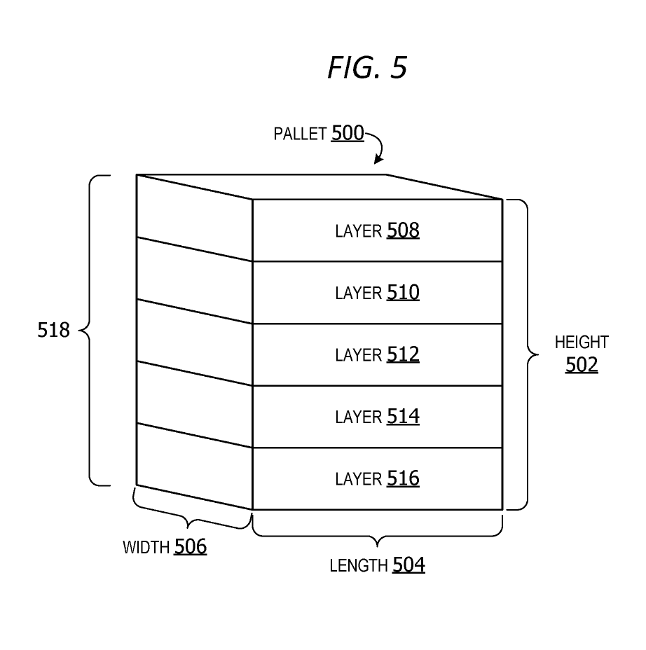

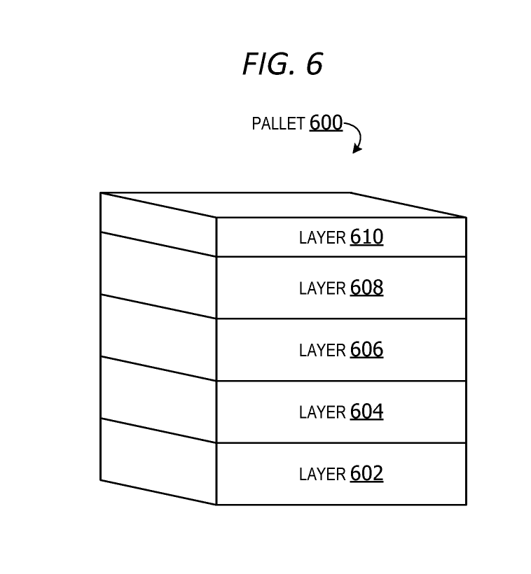

The dynamic item location data 230 in these examples includes a layer ID 304. The layer ID 304 identifies a given layer in a plurality of layers for a given pallet, such as, but not limited to, the plurality of layers associated with a pallet 500 in FIG. 5 and/or the pallet 600 in FIG. 6.

The dynamic item location data 230 in other examples includes placement data 306. The placement data 306 identifies a three-dimensional location of an item placed on a pallet. The placement data 306 in this example includes height 308 data, width 310 data, and length 312 data. The placement data 306 also includes orientation 314 data. The orientation 314 identifies the relative physical position of an item. For example, if an item is packed inside a rectangular-shaped box having a top side, a bottom side, a front-side, a back-side, a left-side and a right-side, the item orientation may specify that the item be place sitting on the bottom side of the box such that a footprint of the box is as small as possible. In another example, the item orientation may specify that the rectangular shaped box be placed with the back-side down increasing the item's footprint and minimizing the vertical height of the box, etc.

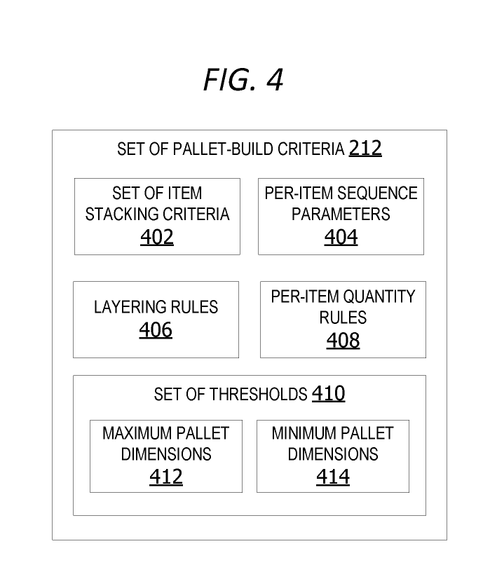

FIG. 4 is an exemplary block diagram of a set of pallet-build criteria 212. The set of pallet-build criteria 212 includes a set of one or more rules for generating pallet-build instructions customized for one or more items to be packed in a given pallet, such as, but not limited to, the pallet-build criteria 124 in FIG. 1.

In this non-limiting example, the set of pallet-build criteria 212 includes a set of item stacking criteria 402. The set of item stacking criteria 402 includes one or more item-specific rules specifying which items may be stacked on top of a given item and which item the given item may be stacked on top of without damaging the items. Stacking criteria 402 are rules defining stacking restrictions for items based on item data, such as, the item size, item dimensions, item weight, strength/fragility, ingredients/chemical composition of item, etc.

For example, the item stacking criteria 402 may specify that paper towel items may be stacked on top of any other items but only paper towels or other items having a weight below some threshold weight may be stacked on top of paper towels. This prevents the paper towel items from becoming smashed or damaged by heavier items.

In another non-limiting example, the set of item stacking criteria 402 may specify that most items may be stacked on top of reams of paper. The set of stacking criteria 402 may require that reams of paper only be stacked on other reams of paper to prevent the relatively heavy items from damaging other more fragile items.

Per-item sequence parameters 404 in some examples includes rules specifying sequence in which items should be placed on a pallet. For example, a sequence parameter for the reams of paper may require that reams of paper be placed on a pallet before paper towels and glassware items to prevent the heavier reams of paper from damaging more fragile items. Another sequence parameter may specify that glass jars be placed on a pallet after heavier items such as weights, books, or tools, such as hammers, to prevent the fragile glass items from breaking during transit.

Layering rules 406 may include one or more rules for creating layers for a pallet. The layering rules 406 may provide preconfigured layer dimensions, such as standard layer dimensions to be used in lieu of generating customized layer dimensions. The layering rules 406 may include a maximum threshold number of layers per pallet, a minimum number of layers per pallet, a minimum size for a layer, a maximum size for a layer, etc. The minimum size for a layer includes minimum layer dimensions defining minimum size for a single layer. The maximum size for a layer includes maximum layer dimensions defining a maximum size for a single layer.

The per-item quantity rules 408 specify the number of items that may be placed on an identified layer of a given pallet or within a given portion of a pallet layer. For example, the per-item quantity rules 408 may specify a maximum number of a heavy item that may be placed at a given location on a pallet. The per-item quantity rules 408 in other examples may define a per-item maximum number of items per-pallet. The per-item maximum number of items may be based on item size and/or item weight. A heavier or larger item may have a lower per-item maximum than a smaller or lighter item. In one non-limiting example, the per-item quantity rules specify a maximum number of twelve microwave ovens in a single pallet and a maximum number of two-hundred boxes of napkins in a single pallet.

The set of thresholds 410 in some examples include maximum pallet dimensions 412 and/or minimum pallet dimensions 414. The set of thresholds 410 is not limited to these examples. The set of thresholds 410 may also include other threshold values.

FIG. 5 is an exemplary block diagram of a pallet having a plurality of uniform layers. The pallet 500 includes a pallet height 502 dimension, a pallet length 504 dimension, and a pallet width 506 dimension.

In some examples, a pallet may be subdivided into a plurality of layers. A layer is defined as the amount of space to fill with items before beginning to calculate the next section/layer of the pallet. For example, if the pallet dimensions for a given pallet is identified as 70 inches height 502, a length 504 of 40 inches, and a width 506 of 48 inches, the system defines two or more layers to fill that available empty pallet space.

The pallet 500 may be subdivided into a plurality of uniform layers. In this example, the plurality of layers 518 includes five layers, layer 508, layer 510, layer 512, layer 514 and layer 516. Each layer in this non-limiting example is fourteen inches high, forty-eight inches wide, and forty inches long. Each layer has substantially the same dimensions and includes substantially the same amount of available space for packing items. However, in other examples, the layers may have different dimensions.

In this non-limiting example, the pallet is subdivided into five uniform layers. However, the examples are not limited to five layers. A pallet may be subdivided into two layers, three layers, or any other number of layers.

The system attempts to completely fill the first layer before adding items to the second layer (next highest layer). The pallet-build instructions in some examples provide instructions for placing items on the first layer 516 (bottom-most incomplete layer) first. The pallet-build instructions output placement instructions for each item beginning with the bottom layer 516 and gradually moving up the pallet layers to the top-most layer 508 in accordance with the item placement sequence.

FIG. 6 is an exemplary block diagram of a pallet having a plurality of non-uniform layers. In this example, the pallet 600 is a pallet for packing a plurality of items for transport of the items to another location. The pallet 600 is subdivided into two or more layers having non-uniform size and/or non-uniform dimensions. In other words, the dimensions of at least one layer are different than the dimension of at least one other layer.

In this non-limiting example, the dimensions of layer 610 are smaller than the dimensions of layers 608, 606, 604, and 602. Layers 602, 604, 606, and 608 are substantially equivalent dimensions. In other examples, every layer in the pallet may have different dimensions.

In other examples, the layer 610 may be larger than the other layers to accommodate items of larger size than items packed in layers 602, 604, and 606. Likewise, layers 602, 604, and 606 may have smaller dimensions to accommodate items of non-uniform size and/or item packing instructions which are more complex than the instructions for packing items in the lower layers.

In other examples, each layer in the plurality of layers in the pallet is dynamically sized based on the dimensions of the items and/or cases of items to be added to the pallet. The pallet 600 has non-uniform layers to accommodate packing of items having different dimensions and/or non-uniform sizes. In some examples, a layer having larger dimensions is defined to accommodate very large items while one or more other layers has smaller dimensions to accommodate packing substantially smaller items.

For example, if a current layer of a pallet is twenty inches high and a next item to be added to the current layer of the pallet is twenty-two inches high, the current layer of the pallet is dynamically adjusted to increase the height of the current layer to twenty-two inches to accommodate the height of the next item to be placed in the current layer of the pallet. Thus, the dimensions of each layer in the plurality of non-uniform layers for a given pallet are determined dynamically in real-time based on the size of the next item in the item placement sequence to be placed on the partially completed pallet.

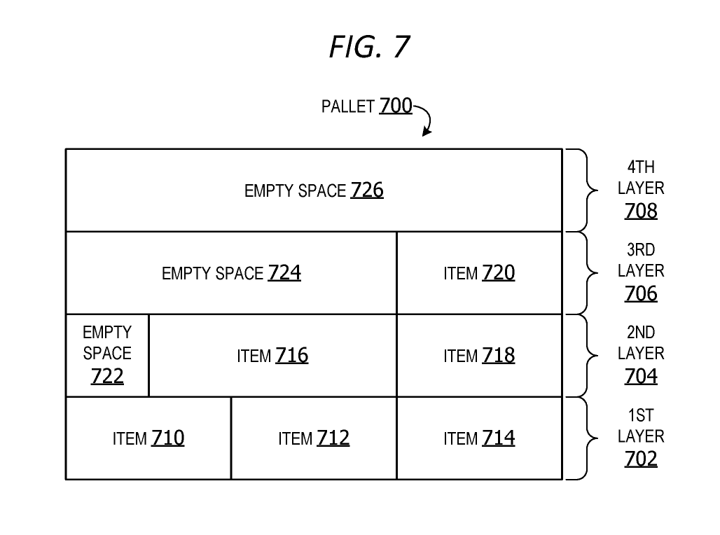

FIG. 7 is an exemplary block diagram of placement of items on a pallet in accordance with pallet layering rules. The partially completed pallet 700 in this example is layered in a sequence of layers, including a first (1′) layer 702, a second (2^{nd}) layer 704, a third (3^{rd}) layer 706, and a fourth (4^{th}) layer 708.

The layering rules in some examples specifies that items be placed on the lowest available layer having empty space sufficient to accommodate the next item in the item placement sequence. If there is not enough empty space in the lowest layer (first layer), the item is placed in the next highest layer up in the pallet that has sufficient empty space available in which the item will fit.

In this example, the first layer 702 is complete. Item 710, 712, and 714 are placed in the first layer 702. There is no remaining empty space on the first layer 702. The second layer 704 is partially complete. Items 716 and 718 are placed in the second layer 704. The next item in the item placement sequence in this example is item 720. However, there is no empty space remaining in the lowest layer (first layer 702). The next highest layer is the second layer 704. However, there is also insufficient empty space remaining in the second layer to accommodate item 720. In other words, the item 720 is too large to fit into the empty space 722 remaining in the second layer. Therefore, the item 720 is placed on the next highest layer up, the third layer 706. The second layer 704 is not complete because there is still empty space 722 remaining in the second layer. Therefore, the next item is the item placement sequence is tested against the remaining empty space 722 in the second layer to determine if the next item will fit in that empty space 722 before the item is placed in the empty space 724 remaining on the third layer. If the next item is also too large to fit within the empty space 724 of the third layer 706, the item is placed in the empty space 726 in the fourth (4^{th}) layer 708 of the pallet.

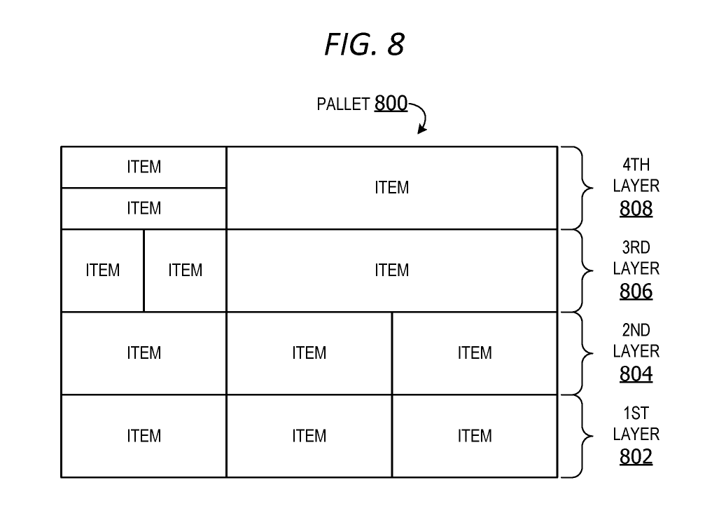

FIG. 8 is an exemplary block diagram of a pallet 800 having a plurality of items placed within a plurality of uniform layers. In this non-limiting example, the pallet 800 is subdivided into a set of uniform layers, including layer 802, layer 804, layer 806, and layer 808. Each layer in the plurality of layers are of uniform dimensions (equal height, width, and length). The layers are of uniform height in this example because each item in the plurality of items placed on the pallet 800 have dimensions capable of fitting within the same size layers of the pallet.

In this example, the pallet includes four layers. However, in other non-limiting examples, the pallet 800 may include two layers, three layers, as well as five or more layers. The layers may be any dimensions suitable to accommodate the items to be placed in that layer.

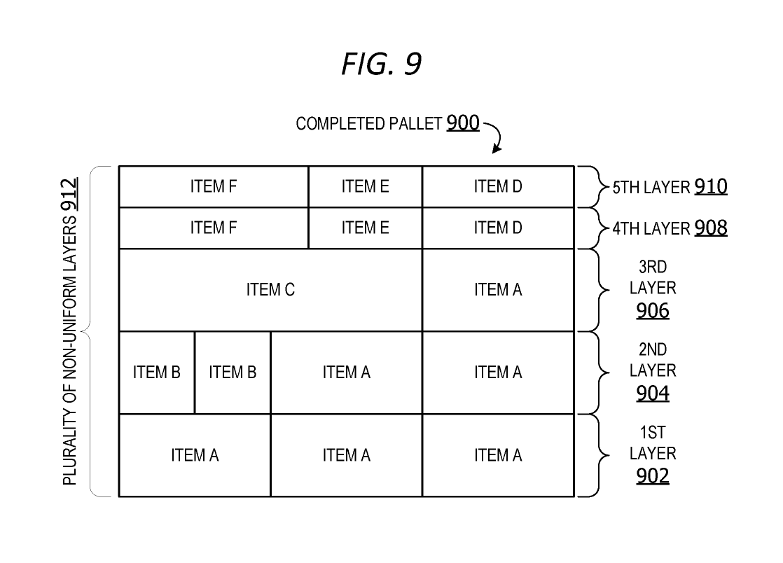

FIG. 9 is an exemplary block diagram of a pallet 900 having a plurality of items placed within a plurality of non-uniform layers 912. In this non-limiting example, the pallet 900 is subdivided into a set of non-uniform layers, including but not limited to, layer 902, layer 904, layer 906, layer 908, and layer 910. Each layer in the plurality of layers are of non-uniform dimensions (equal height, width, and length). In this example, layers 902, 904 and 906 are of substantially the same dimensions. However, layers 908 and 912 have smaller dimensions than the layers 902, 904, and 906.

In this example, the pallet includes five layers. However, in other non-limiting examples, the pallet 800 may include two layers, three layers, four layers, as well as six or more layers. The layers may be any dimensions suitable to accommodate the items to be placed in each layer.

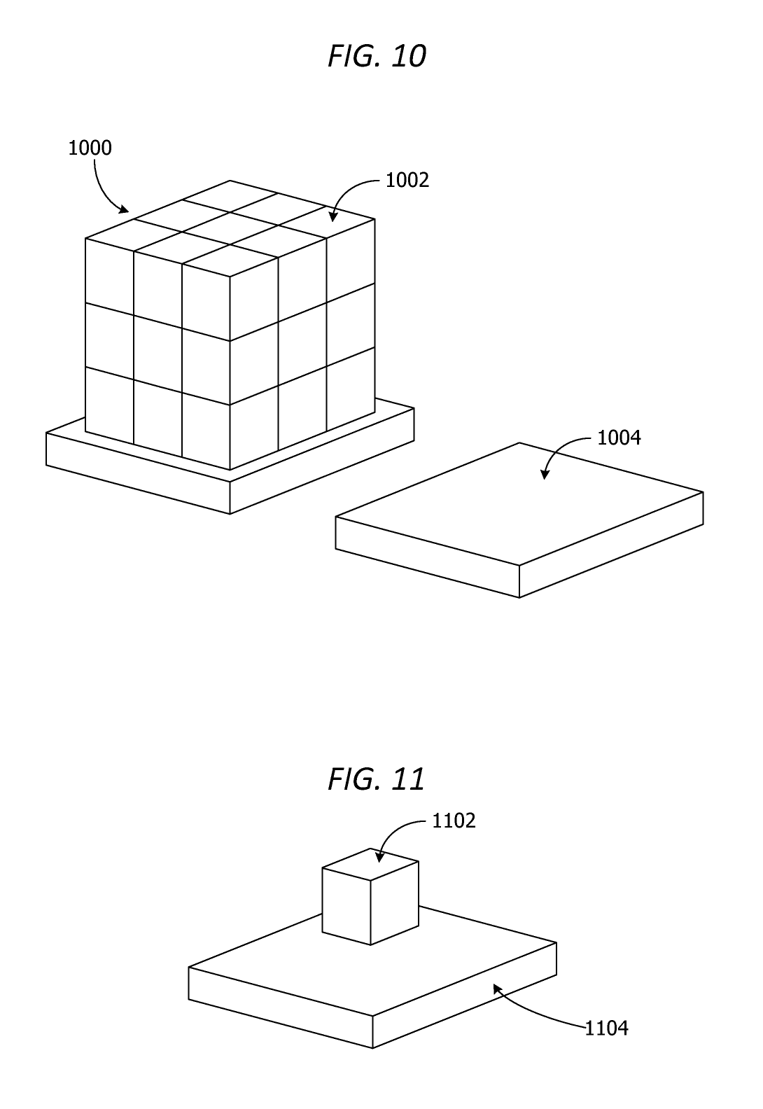

FIG. 10 is an exemplary block diagram of an AR image 1000 providing pallet-build instructions for building a pallet 1002. The AR image in this example provides a virtual reality image of a plurality of items to be placed on a planned pallet 1002 that has not yet been built.

In some examples, when a user begins a pallet-build process to build a pallet, the user device associated with the user outputs a projected planned pallet- build with all cases shown in a planned placement, as shown in 1002. In this non-limiting example, the items to be placed on the planned pallet, is shown in grey. In other example, the items to be placed on the planned pallet may be shown in any user-selected color, such as green, blue, orange, or any other color.

Upon beginning the order filling trip, an additional three-dimensional (3-D) image is displayed alongside the planned pallet build, with a graphic 1004 that reflects the current items stacked on the pallet. In this example, the graphic 1004 showing the current state of the partially build pallet is empty because no items have yet been placed on the first layer of the planned pallet.

In this example, the graphic 1004 represents a lowest layer of a pallet on which no items have yet been placed. The dimensions of the pallet may be any configurable dimensions. In one non-limiting example, the pallet dimensions are forty inches by forty-eight inches by eighty inches (40 in.×48 in.×80 in.).

FIG. 11 is an exemplary block diagram of an AR dynamic pallet-build instructions 1100 for a next item in an item placement sequence. The dynamic pallet-build instructions 1100 in this example shows an assigned location 1102 for the next item to be placed on the first layer of the planned pallet 1104.

When the user identifies that they are at a next item in the item placement sequence of the order-filling trip, the system identifies the assigned location 1102 of the next item on the pallet 1104. In one non-limiting example, the representation of the assigned location for the next item is green or some other pre-designated color to alert user of the correct assigned location for the item being placed on the pallet 1104.

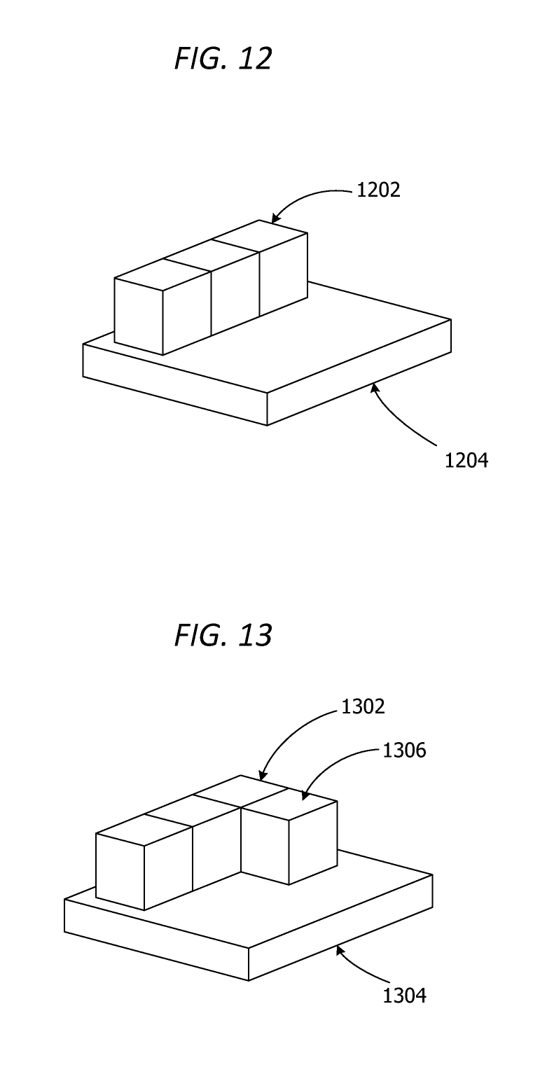

FIG. 12 is an exemplary block diagram of an AR display 1200 showing a plurality of items 1202 placed on a partially completed pallet 1204. The items 1202 are items already placed on the partially completed pallet 1204. In this non-limiting example, as the user moves through the order filling trip, the AR display 1200 updates by populating with items that are being stacked on the pallet 1204 in real-time.

FIG. 13 is an exemplary block diagram of an AR dynamic pallet-build instructions 1300 outputting a next assigned location for a next item 1306 to be placed on the partially completed pallet 1304 in an item placement sequence. The items 1302 are the items already placed in a correct location on the pallet 1304. These items are shown in green in this non-limiting example. However, the already placed items may be shown in any color.

In this non-limiting example, if a user identifies that an item is placed in a different location than recommended, the system marks the item in red or any other predetermined color for indicating an incorrectly placed item. For example, an incorrectly placed item may be an orange color, a yellow color, a purple color, or any other color for indicating misplaced items.

In other examples, the system is not limited to identifying an incorrectly placed item using a color indicator. In other examples, incorrectly placed items may be marked or identified using any type of indictor or alert. For example, a misplaced item may be identified by a flashing or blinking icon, an arrow pointing to the incorrectly placed item, an “x” icon placed over the image of the incorrectly placed item, or any other indicator identifying an item that is misplaced.

The user may identify an incorrectly placed item using a user interface associated with a user device of the user, such as the user device 132 in FIG. 1. In other examples, the user may identify an incorrectly or misplaced item via verbal input provided to a voice-recognition system. In still other examples, the system analyzes sensor data generated by a plurality of sensors associated with a pallet-build area to identify an incorrectly placed item without any user input, such as the set of sensor devices 126 in FIG. 1.

In some examples, the incorrectly placed item is an item placed incorrectly relative to a previously placed item in the item placement sequence. In other examples, the incorrectly placed item is an item placed at an incorrect location on the pallet. The incorrect location may be placement of the item on the wrong layer or placement of the item at the wrong location within the correct layer of the pallet. In still other examples, the incorrectly placed item is an item placed in the correct location within the correct pallet layer but placed in an incorrect orientation. For example, if an item is assigned to an orientation in which the item is to be placed horizontally with one-side down, but the item is placed vertically with the bottom-down, the item is in an incorrect orientation.

If the location of a misplaced item is temporary, the user can move on to next item and later utilize an input device or other technology to identify when the incorrectly placed item has been moved to the correct, assigned-location. When the item is moved to the correction assigned location, the graphic in the AR display representing the item turns green, or any other appropriate color, to indicate the item is in the correct location.

If the location of the misplaced item is identified as permanent, the system recalculates a possible feasible solution to create a new 3-D optimal pallet build model. If it is feasible, the user can move on to the next item. If it is not feasible to create a modified pallet-build, the user is directed to move the item to the correct location.

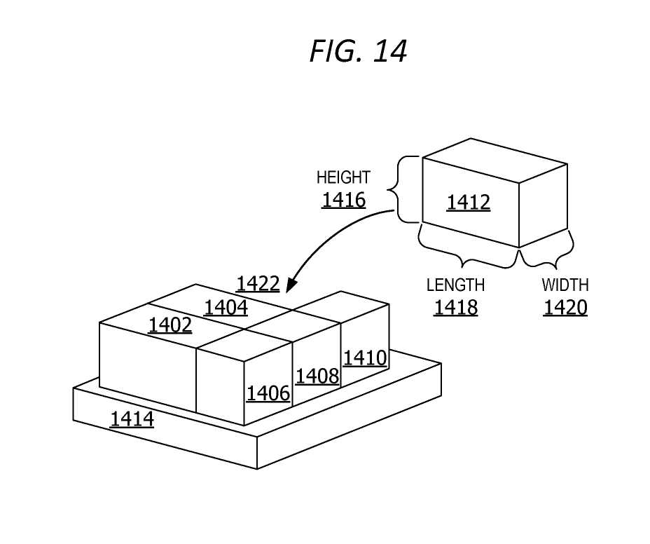

FIG. 14 is an exemplary block diagram of dynamic pallet-build instructions 1400 in an AR format providing an identification of a next item in the item placement sequence and an identification of the assigned location for the next item to be placed on a partially completed pallet 1414. The partially completed pallet 1414 includes items 1402, 1404, 1406, 1408, and 1410 placed on a first layer of the pallet 1400. The next item 1412 to be placed on the pallet 1414 is identified in the dynamic pallet-build instructions 1400 output to the user.

The dimensions for item 1412 include a height 1416, a length 1418, and a width 1420 of the item 1412. If the dimensions of the item 1412 are small enough to fit into within the empty space 1422 remaining on the first (1′) layer 1424 of the pallet, the item 1412 is placed on the first layer 1424 of the pallet 1414. In some examples, the system compares the dimensions of the item 1412 with the dimensions of the empty space 1422 to determine if the item fits within the remaining empty space 1422 of the first layer.

If the item 1412 is too large to fit into the remaining empty space 1422, the item 1414 is placed on the next layer of the pallet 1414. If there are no remaining unfilled layers of the pallet or the item 1414 is too large for the remaining space in the remaining one or more layers of the pallet, the item 1414 is assigned to a next pallet.

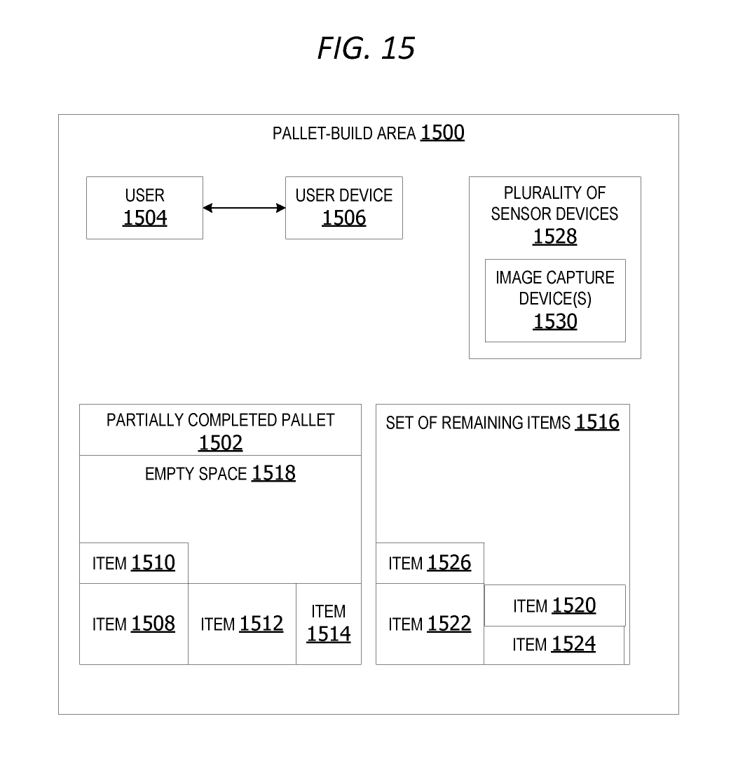

FIG. 15 is an exemplary block diagram of a pallet-build area 1500 including a partially build pallet 1502. The partially completed pallet 1502 in this example is a pallet being assembled by a user 1504. The user 1504 receives dynamic pallet-build instructions via a pallet-build application running on a user device 1506, such as, but not limited to, the pallet-build application 136 in FIG. 1. The user device 1506 may include an AR generator for outputting pallet-build instructions including AR images providing an identification of a next assigned location for a next item in an item placement sequence to be placed on the partially completed pallet 1502. The AR images include 3-D graphical elements representing the next item in the item placement sequence and/or the assigned location for the next item.

The partially completed pallet 1502 includes items 1508, 1510, 1512, and 1514 already placed on the pallet 1502. The AR display may include the real-world images of the item already placed on the pallet and/or graphical elements representing these items.

The set of remaining items 1516 includes one or more items selected for inclusion within the pallet 1502 which have not yet been placed on the pallet. The set of remaining items 1516 in this non-limiting example includes item 1520, item 1522, item 1524, and item 1526. The remaining items are selected for placement within the empty space 1518 on the partially completed pallet 1502 in the order specified by the item placement sequence. For example, but without limitation, the item placement sequence may specify that item 1522 be placed on the pallet first because it is larger and/or heavier than the other remaining items. The item placement sequence may then specify that items 1520 be placed on the pallet second, item 1524 be added to the pallet third, and item 1526 be packed on the pallet last.

The pallet-build area 1500 in some examples include a plurality of sensor devices 1528 for generating sensor data associated with the one or more items placed on the pallet 1502, such as, but not limited to, the set of sensor devices 126 in FIG. 1. The plurality of sensor devices 1528 may include one or more image capture device(s) 1530 generating images of items on the pallet and/or items not yet placed on the pallet. The plurality of sensor devices may also include infrared imaging sensors, weight sensors, proximity sensors, RFID tag readers, barcode scanners for reading universal product code (UPC) labels, beacon transmitters, beacon receivers, matrix barcode readers, or any other type of sensor devices. The plurality of sensor devices 1528 generates sensor data associated with the partially built pallet 1502.

The sensor data is analyzed by the dynamic pallet-build component to identify the assigned location of each item already placed on the pallet. The assigned location of items already placed on the pallet are used to dynamically determine the optimal location for the next item in the remaining items 1516 to be placed on the pallet in accordance with the item placement sequence.

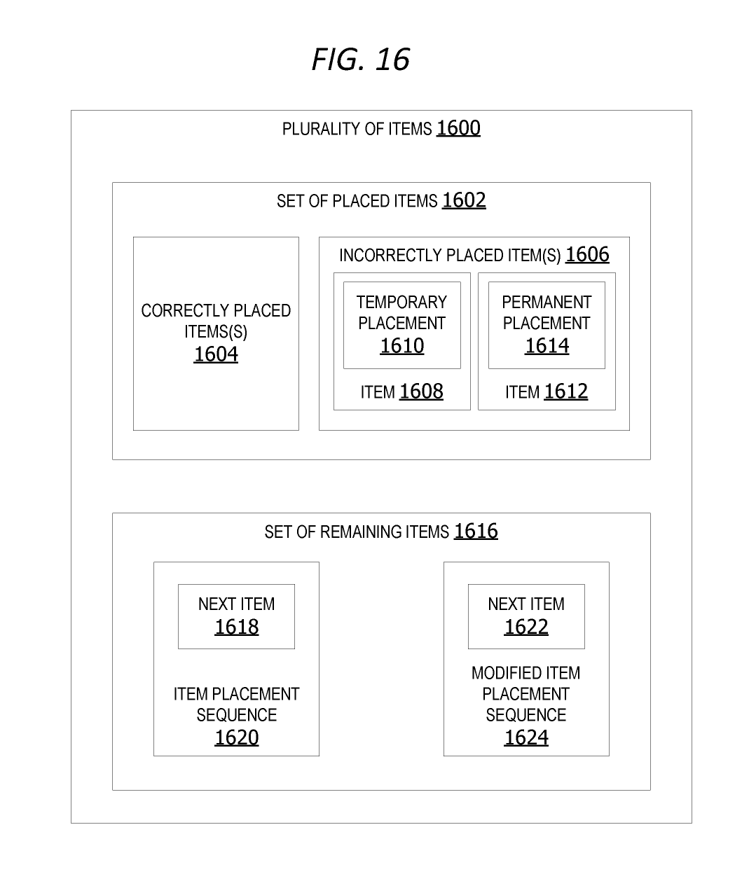

FIG. 16 is an exemplary block diagram of a plurality of items 1600 associated with a pallet-build. The plurality of items 1600 includes a set of placed items 1602. The set of placed items 1602 includes one or more items already placed on a partially built pallet. The set of placed items 1602 may include one or more correctly placed item(s) 1604 and/or one or more incorrectly placed item(s) 1606. Incorrectly placed item(s) 1606 may include an item 1608 in a temporary placement 1610. A temporary placement indicates an item is placed in a temporary location which will be changed before the pallet-build is complete.

The incorrectly placed item(s) 1606 may also include a permanent placement 1614. The permanent placement 1614 is a permanent placement location for an item that will not be changed prior to completion of the pallet build.

The set of remaining items 1616 is a set of one or more items in the plurality of item 1600 to be placed on the partially build pallet which have not yet been placed on the pallet. The set of remaining items 1616 includes a next item 1618 to be placed on the pallet in accordance with an item placement sequence 1620. If the item placement sequence is modified due to an incorrectly placed item, the set of remaining items 1616 may include a different next item 1622 to be placed on the pallet in accordance with the modified item placement sequence 1624.

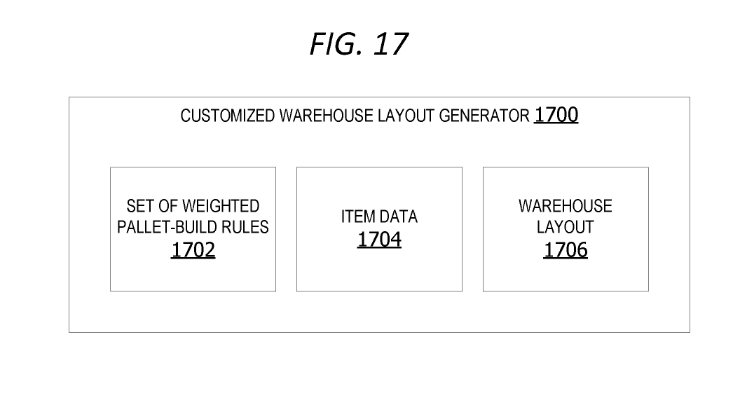

FIG. 17 is an exemplary block diagram of a customized warehouse layout generator 1700. The customized warehouse layout generator 1700 analyzes item data 1704 using a set of weighted pallet-build rules 1702 to generate a warehouse layout 1706 specifying a layout for each item in the plurality of items stored in a warehouse, store room, or other storage area. The item data 1704 in some examples may include item dimensions, item size, weight of item, center of gravity for item, fragility of item, cost/expense/value of item, etc.

In some non-limiting examples, the customized warehouse layout generator 1700 designs an optimal warehouse layout to accommodate items to be picked such that heavier, stronger items are placed on the bottom and the more fragile or lighter items are placed towards the top, or another configuration of such that reflects optimal pallet building for execution.

The dynamic pallet-build component utilizes the warehouse layout 1706 to perform pallet-optimization calculations based on where one or more items are stores in a warehouse or other storage area. The warehouse layout 1706 identifies a storage location of one or more items based on item placement sequence, weight of items, size of items, dimensions of items, stacking criteria, cost/value of items, fragility of items, item group/classification, pick type, pick volume, pick time, and/or item temperature.

The pick type refers to a full pallet pull, each pick, or a case pick. The pick volume refers to a high quantity versus a low quantity pick. The pick time refers to how long it takes to pick items and quantities of items.

The customized warehouse layout generator 1700 arranges items inside a warehouse based on rules input. The set of weighted pallet-build rules 1702 may be weighted in the algorithm, such as to generate a layout which minimizes time, number of users required to build a pallet, cost to build the pallet, and/or number of loaders required to move cases to the pallet-build area. In one non-limiting example, if the set of weighted pallet-build rules 1702 is weighted to optimize pallet-build for cost, the customized warehouse layout generator 1700 designs the warehouse layout 1706 to place the heaviest items first in the pick sequence.

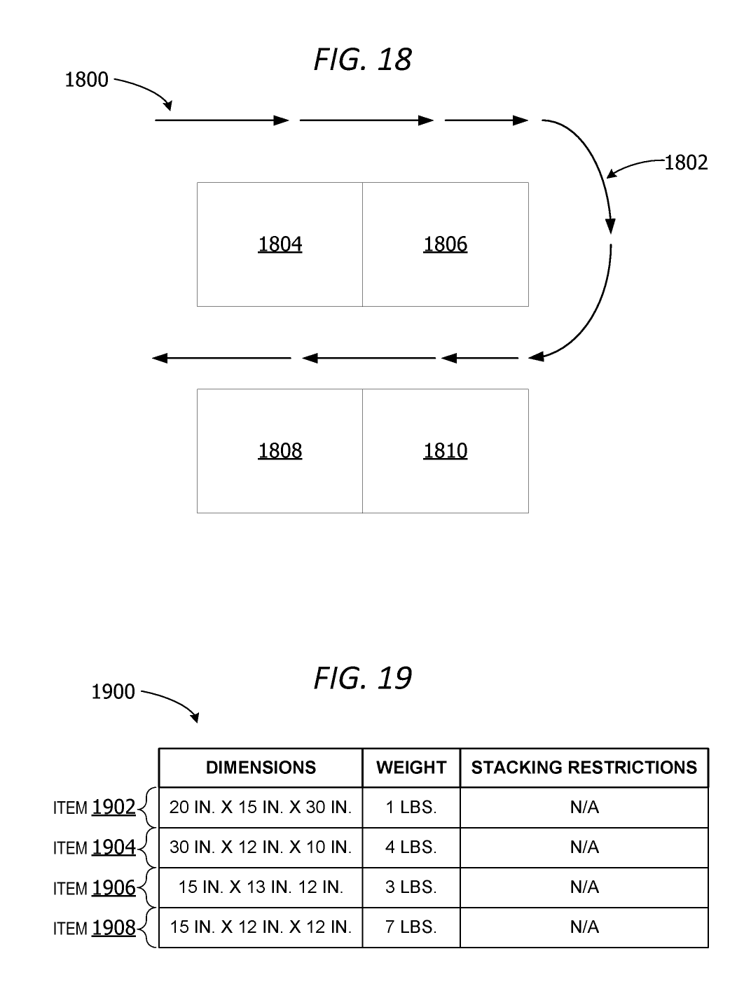

FIG. 18 is an exemplary block diagram of a customized warehouse layout 1800. The warehouse layout 1800 is a layout dictating placement of cases of items to be used for one or more pallet-builds within a pallet-build area. The cases of items are placed along a pallet-build line 1802 in one or more spaces, such as space 1804, 1806, 1808, and/or 1810 to enable pallet-builders to obtain items in a correct order to build pallets.

In some examples, heavy and/or large items to be placed in a bottom or lowest layer of a pallet are located at the front of the pallet-build line 1802, such as at space 1804 and/or 1806. Items which are light, small, and/or fragile in this non-limiting example are placed at the back of the pallet-build line, such as at space 1810 and/or 1808.

In other examples, items are placed along the pallet-build line 1802 based on stacking criteria. Items which may not be stacked on other items are placed at the front of the pallet-build line 1802. Items which are permitted to be stacked on top of other items in the pallet are placed towards the end of the pallet-build line 1802, such as at space 1810 and/or 1808.

FIG. 19 is an exemplary table illustrating item dimensions for a set of items 1900. The dynamic pallet-build component determines a location for each item in the set of items based on the item dimensions. The item dimensions in some examples are stored in the item data for each item.

In some examples, the dynamic pallet-build component utilizes dimensions of items and item placement sequence to determine the optimal stacking and loading of items on a pallet. The dynamic pallet-build component utilizes the item dimensions for the next item in the item placement sequence with the stacking criteria and dimensions of empty space associated with the pallet to generate the assigned placement location for the next item in the sequence.

The first pick item in this non-limiting example is item 1902 based on warehouse layout and the item dimension (20-inch x 15-inch x 30-inch). There are five cases of item 1902 to be picked. Item 1904 is the second pick item based on the warehouse layout and item dimensions (30-inch x 12-inch x 10-inch). There are ten cases of item 1904 to be picked. Item 1906 is the third pick item based on the warehouse layout and item dimensions (15-inch x 13-inch x 12-inch). There are thirty cases to be picked for item 1906. Item 1908 is the fourth pick item based on the warehouse layout and dimensions (15-inch x 12-inch x 12-inch). There are 10 cases to be picked.

The item 1902 is the largest item but item 1902 has the lightest weight. Item 1908 has the smallest dimensions and the largest weight. In this example, item 1908 is placed on the pallet first due to its weight. Item 1904 is placed second, item 1906 is placed third, and item 1902 is placed on the pallet last based on weight.

In another example, item 1902 may be placed on the pallet first due to its size if there are no stacking restrictions/stacking criteria associated with the set of items 1900. In this example, item 1904 is placed second, item 1906 is placed third, and item 1908 is placed fourth on the pallet.

FIG. 20 is an exemplary flow chart illustrating operation of the computing device to assign items to pallet layers in accordance with pallet layering rules. The process shown in FIG. 20 may be performed by a dynamic pallet-build component executing on a computing device, such as the computing device 102 in FIG. 1.

The process begins by identifying dimensions of a next item in an item placement sequence at 2002. The item placement sequence is an order of placement of items onto a pallet, such as the item placement sequence 218 in FIG. 2.

The dynamic pallet-build component identifies dimensions of empty space on a lowest incomplete pallet layer at 2004. The incomplete pallet layer is a layer in a plurality of layers associated with a pallet, such as, but not limited to, the layer 416 in FIG. 4, the layer 510 in FIG. 5, the layer 702 in FIG. 7, the layer 802 in FIG. 8, and/or the layer 902 in FIG. 9.

The dynamic pallet-build component determines if there is sufficient space to accommodate the item at 2006. If yes, the dynamic pallet-build component assigns the item to a location in the layer at 2008. The dynamic pallet-build component determines if there is a next item in the item placement sequence at 2010. If no, the process terminates thereafter.

If there is insufficient space available on the layer to accommodate the item at 2406, the dynamic pallet-build component determines if there is a next layer of the pallet at 2012. If yes, the dynamic pallet-build component identifies dimensions of empty space in the next highest pallet layer at 2014. The dynamic pallet-build component determines if there is sufficient space on the pallet layer to accommodate the item at 2006. If yes, the item is assigned to a location in the layer at 2008. The dynamic pallet-build component determines if there is a next item in the sequence at 2010. If no, the process terminates thereafter.

Returning to 2010, if there is a next item in the sequence, the dynamic pallet-build component determines the dimensions of the next item in the sequence at 2002. The dynamic pallet-build component iteratively executes operations 2002 through 2012 until there are no remaining item left in the item placement sequence at 2010 or there are no remaining layers remaining on the pallet at 2012 and the pallet-build is complete. The process terminates thereafter.

While the operations illustrated in FIG. 20 are performed by a computing device, aspects of the disclosure contemplate performance of the operations by other entities. For example, a cloud service may perform one or more of the operations.

FIG. 21 is an exemplary flow chart illustrating operation of the computing device to generate dynamic pallet-build instructions. The process shown in FIG. 21 may be performed by a dynamic pallet-build component executing on a computing device, such as the computing device 102 in FIG. 1.

The process begins by generating pallet-build instructions including an item placement sequence for each item at 2102. The dynamic pallet-build component analyzes sensor data at 2104. The sensor data is data generated by a set of sensor devices associated with a pallet-build area, such as the set of sensor devices 126 in FIG. 1.

The dynamic pallet-build component identifies an item placement for item(s) placed on the partially completed pallet at 2106. The dynamic pallet-build component generates dynamic item location data for item(s) already placed on the pallet at 2108. The dynamic item location data is data associated with a placement of one or more items on a pallet, such as the dynamic item location data 230 in FIG. 2.

The dynamic pallet-build component determines if an item is incorrectly placed at 2110. If yes, the dynamic pallet-build component modifies the item placement sequence for the remaining item(s) at 2112. The dynamic pallet-build component outputs the next assigned location of a next item in the modified item placement sequence to a user at 2114. The next assigned location may be output to a user device associated with the user, such as the user device 132 in FIG. 1. The process terminates thereafter.

Returning to 2110, if the dynamic pallet-build component determines all items are correctly placed at assigned locations on the partially built pallet, the dynamic pallet-build component outputs a next assigned location of a next item in the item placement sequence at 2116. The process terminates thereafter.

While the operations illustrated in FIG. 21 are performed by a computing device, aspects of the disclosure contemplate performance of the operations by other entities. For example, a cloud service may perform one or more of the operations.

FIG. 22 is an exemplary flow chart illustrating operation of the computing device to generate a modified item location in response to an incorrectly placed item. The process shown in FIG. 22 may be performed by a dynamic pallet-build component executing on a computing device, such as the computing device 102 in FIG. 1.

The process begins by analyzing sensor data at 2202. The sensor data is data generated by sensor(s) associated with a pallet-build area, such as the sensor data 122 in FIG. 1. The dynamic pallet-build component identifies an incorrectly placed item on the partially completed pallet at 2204. The dynamic pallet-build component sends a temporary placement query to a user device associated with the user at 2206. The user device may be a smart phone, a smart tablet, smart glasses, or any other type of user device, such as, but not limited to, the user device 132 in FIG. 1 and/or the user device 1506 in FIG. 15.

The dynamic pallet-build component determines if a permanent placement status is received at 2208. If yes, the dynamic pallet-build component outputs dynamically modified next assigned location for a next item in the item placement sequence at 2210. The process terminates thereafter.

Returning to 2208, if a permanent placement status is not received, the dynamic pallet-build component outputs an unmodified next assigned location of a next item in the unmodified item placement sequence at 2212. The process terminates thereafter.

While the operations illustrated in FIG. 22 are performed by a computing device, aspects of the disclosure contemplate performance of the operations by other entities. For example, a cloud service may perform one or more of the operations.

FIG. 23 is an exemplary flow chart illustrating operation of the computing device to generate item location data based on temporary placement status of items. The process shown in FIG. 23 may be performed by a dynamic pallet-build component executing on a computing device, such as the computing device 102 in FIG. 1.

The process begins by analyzing dynamic item location data at 2302. The dynamic pallet-build component determines if an item is placed in an unassigned location at 2304. If yes, the dynamic pallet-build component sends a query requesting placement status of the item at 2306. The dynamic pallet-build component determines if a temporary placement status is received at 2308. If yes, the dynamic pallet-build component outputs an unmodified next assignment placement for a next item in the unmodified item placement sequence at 2310. The process terminates thereafter.

Returning to 2304, if an item is not detected in an unassigned location, the dynamic pallet-build component outputs an unmodified next assignment placement for a next item in the unmodified item placement sequence at 2310. The process terminates thereafter.

Returning to 2306, if a temporary placement status is not received, the dynamic pallet-build component outputs a modified next assigned location for a next item in a modified item placement sequence at 2312. The process terminates thereafter.

While the operations illustrated in FIG. 23 are performed by a computing device, aspects of the disclosure contemplate performance of the operations by other entities. For example, a cloud service may perform one or more of the operations.

### Additional Examples

In some examples, the system analyzes item planned for loading and assigns location for the items on the pallet. The system includes a user interface which provide 3-D images for user building pallets. The system outputs instructions to the user for loading the items via the 3-D images on the user interface. The system provides alerts to the users in case any error occurs during loading of the pallets.

The dynamic pallet-build system in other examples considers the shape and size of the object, as well as item weight and type of item packaging for calculating dynamic item location assignment. For example, if a first item which is heavier than a second item is to be placed on the lowest pallet layer, but a lighter second item is mistakenly placed on a lower layer instead of the first item, the system recalculates item location assignments to ensure only other instances of the second item or other items lighter than the second item are placed on top of the second item in the modified item placement sequence.

The system dynamically generates and modifies pallet location assignments/pallet build instructions in real-time based on where a last item in a pallet loading sequence is placed on the pallet in other examples. When an item is placed in a wrong location, the system generates new assignments/instructions for remaining items to be placed on the pallet to auto-correct rather than simply providing an alert to the user to move the last item already placed on the pallet.

In some examples, items placed on the pallet are all regular shapes, such as cube shaped cases. However, in other examples, the items placed on the pallet are irregular shaped items. In these examples, the system dynamically calculates a placement location and orientation of the object that adjusts for any irregularities in the item shape.

The system dynamically adjusts/modifies the assigned locations of items to be placed on a pallet based on the actual placement location of items already on a partially built pallet. In some examples, the system only modifies the assigned locations of one or more items which are going to be placed on the pallet. In other examples, the system only modifies the sequence/order in which the items are going to be placed on the pallet. In still other examples, the system modifies both the assigned locations of the items and the item placement sequence.

In an example scenario, the dynamic pallet-build component analyzes item data and pallet dimensions to generate a plurality of pallet layers and assign items to one or more locations within an identified pallet layer based on item placement sequence to optimize volumetric efficiency within the pallet for each pallet in real-time based on actual placement of items during the pallet-build process.

The system in some examples calculates dimensions of a planned pallet and layer dimensions for each layer based on a set of items assigned to the planned pallet. An item placement sequence is calculated based on item dimensions and optimization of pallet space. A next location with item orientation is calculated for the next item in the item placement sequence to be placed on the current layer of the pallet while minimizing un-used space in each layer of the pallet.

The system in other examples plans the complete loading of a pallet in an efficient manner by analyzing the items planned for a truck or store load and combining these items into one or more pallets required for the load. The system assigns specific cartons/cases to assigned locations in each pallet. The system adjusts the order of items to be picked to efficiently place the heavier, stronger items on the bottom of the pallet and the more fragile/lighter items towards the top.

A user building the pallet receives instructions identifying a next item in an item placement sequence and an assigned location on the pallet for the next item from a user device, such as smart glasses. The user picks the identified next item and places the next item in the indicated location on the pallet. In some examples, a 3-D like generated display shows the user a representation of the pallet and items already placed on the pallet as the loading process continues.

In some non-limiting examples, the user device generates a display first showing an AR image of the empty pallet with dotted grey lines indicating where a next item in the item placement sequence should be placed in accordance with an assigned location of the item. The smart display provides cues to the picker indicating where to go in the warehouse or storage area to get the next item in the sequence. Once the next item is picked, the system displays the assigned location for the item/carton in green. In the event the picker places an item/carton in the wrong location on the pallet, the system performs calculations to identify whether an efficient, safe load is possible. If this is not possible, the system provides audible cues and shows the previous package in red to indicate that the user should move the item/carton. The system enables the user to temporarily place items/cartons on the pallet for subsequent re-packing to optimize the user's route through the pallet load cycle.

A user interface is provided in some examples to output 3-D images containing item loading instructions for one or more users assembling a pallet. The system alerts the one or more users in case any error occurs during the loading process.

A dynamic pallet-build component is provided in other examples to dynamically generate pallet-build instructions to order-fill a pallet. The pallet-build instructions include a plan for boxes to be packed together in a pallet by a user as the user goes down an order-filling line. The instructions direct the order-filler as to which item/box goes in which spot on the pallet in a specific orientation and sequence. If an order-filler places one or more boxes in such a way an incorrect order or incorrect placement location, it disrupts the pallet space utilization.

Therefore, if an item/case is placed incorrectly on the pallet (wrong place or wrong position), the system alerts the user to correct the error and/or direct the user to move the item to a different position which may be more optimal. In some examples, the dynamic pallet-build component generates modified pallet-build instructions updating the item placement sequence and/or changing the assigned location of one or more items to optimize the pallet in view of the incorrectly placed item(s) using variables such as weight, cube, box size, etc. The system dynamically creates a new plan for other boxes which have not yet been added to the pallet for real-time optimization of box placement within a pallet. In this manner, the system auto-corrects if an item or box is placed in the wrong place.

In another example, the system creates a plan for building a pallet using a set of items to be added to the pallet, the system creates a set of pallet-build instructions, including an item placement sequence and assigned location for each item. If user does not follow the instructions, the dynamic pallet-build component creates a new/updated set of pallet-build instructions based on where the last item or last box was placed. The dynamic pallet-build component utilizes AR to direct users as they order-fill each pallet. The dynamic pallet-build component calculates on an on-going basis where each item should be placed for optimal pallet filling.

If an item is placed in an incorrect location, the dynamic pallet-build component generates dynamic item location data based on analysis of sensor data, such as camera images/visual cues in real-time. The dynamic pallet-build component utilizes the pallet dimensions and item dimensions to create updated pallet-build instructions. The dynamic pallet-build component analyzes the dynamic item location data to determine whether to adjust/update the pallet-build instructions or whether the original pallet-build instructions still provide the most optimized utilization of pallet space.

In some examples, if a box is placed in the wrong spot on a pallet, the dynamic pallet build component determines how the pallet-build is impacted and whether an alternate/modified build is possible that improves on volumetric efficiency and space utilization in the pallet. In other words, the system optimizes item placement on a pallet using the minimal space possible on the pallet.

The system in other examples enables the user to interact with the pallet-build instructions. If the user places an item in an incorrect location, the user may interact with the system by touching a location and confirming the placement is permanent or temporary. The image output changes to indicate whether the new/incorrect placement is acceptable or unacceptable.

In still another example, the system determines if a warehouse layout is available. If not, the system creates a warehouse layout using pallet load optimization. The system identifies orders generated for store deliveries. The system creates/optimizes pallet-build instructions, including pallet stacking plans. The pallet stacking plans are loaded into a user device, such as an order-fillers smart glasses/smart tablets. The order-filler begins order-filling trip using 3-D templates created during pallet stacking plans. The order-filler uses equipment to scan for pick item. The 3-D image in the user device highlights the planned/assigned placement location for the scanned item (next item in sequence). The system determines if the user placed the item in the correct location on the pallet. If the item is correctly placed, the 3-D image of the item turns green. If the item is incorrectly placed, the system determines if the incorrect placement is permanent. If it is not permanent, the system highlights the item in red until the user places the item into the correct location on the pallet. If the incorrect placement is temporary, the system recalculates modified pallet-build instructions, including modified stacking plan for feasibility of the modified pallet-build. If the plan is feasible, the system highlights the incorrectly placed item in green indicating the incorrect placement is accepted as a permanent new location for the item on the pallet. If the plan is not feasible, the system outputs instructions indicating the current location of the item is unacceptable and directing the user to move the item to the correct location or a modified new location. The system iteratively performs these operations for each item in the item placement sequence until the pallet-build is complete.

Alternatively, or in addition to the other examples described herein, examples include any combination of the following:
a selection component, implemented on the at least one processor, that selects a first set of items from a plurality of items for inclusion within a first layer of a proposed pallet and selects a second set of items from the plurality of items for inclusion within a second layer of the proposed pallet based on the item data, proposed pallet dimensions, a set of item stacking criteria, and a warehouse layout;
a customized warehouse layout generator, implemented on the at least one processor, that generates a warehouse layout for a plurality of items based on a set of weighted rules and item data;
the item data includes at least one of an item weight, item size, item grouping, pick type, pick volume, pick time, item temperature, and stacking criteria associated with each item in the plurality of items;
a query component, implemented on the at least one processor, that outputs a query to the user device via the communications interface component, the query requesting a temporary placement status of an incorrectly placed item, wherein the interactive pallet-build component outputs an unmodified next assigned location for a next item in the item placement sequence in response to receiving the temporary placement status;
wherein the interactive pallet-build component outputs a dynamically modified next assigned placement location for the next item in the item placement sequence in response to receiving the permanent placement status;
wherein the interactive pallet-build component generates the modified item placement sequence based on dynamic item location data, a set of remaining items to be placed on the partially completed pallet, an amount of available space in the partially completed pallet, and the item data;
wherein the modified item placement sequence changes an order in which items are added to the partially completed pallet;
an alert component, implemented on the at least one processor, that outputs an alert to the user device identifying an incorrectly placed item and providing instructions for moving the incorrectly placed item to a correct assigned placement location or a modified location assignment;
wherein a placement location assigned to a given item comprises a pallet level, an assigned location within the pallet level, and an orientation of the item at the assigned location within the proposed pallet;
generating a dynamically modifying next assigned location of the next item in the dynamically modified item placement sequence to be placed on the partially completed pallet based on the dynamic item location data;
dynamically generating a modified item assigned location of at least one remaining item to be placed on the partially completed pallet, the modified location assignment comprising at least one of a new pallet level, a new location, and a new item orientation for the next item in the modified item placement sequence;
sending a query requesting a temporary placement status of an incorrectly placed item to the user device in response to detecting an item placed on an incorrect level within the partially complete pallet;
sending a query requesting a temporary placement status of an incorrectly placed item to the user device in response to detecting an item placed in an unassigned placement location;
sending a query requesting a temporary placement status of an incorrectly placed item to the user device in response to detecting an item placed in an incorrect orientation based on a current set of pallet-build instructions;
outputting an unmodified next assigned placement location for a next item in the item placement sequence in response to receiving the temporary placement status;
outputting a dynamically modified next assigned placement location for the next item in the item placement sequence in response to receiving the permanent placement status;
generating a warehouse layout for a plurality of items based on a set of weighted rules and item data;
outputting an alert to the user device identifying an incorrectly placed item and providing instructions for moving the incorrectly placed item to a correct assigned placement location or a modified location assignment;
outputting an alert to the user device identifying the incorrectly placed item and providing instructions for moving the incorrectly placed item to a correct assigned placement location or a modified location assignment for the incorrectly placed item;
selecting a set of items from a plurality of items for inclusion within a first proposed pallet and selects a second set of items from the plurality of items for inclusion within a second proposed pallet based on item data, proposed pallet dimensions, a set of item stacking criteria and a warehouse layout; and
generating a modified item placement sequence for a set of remaining items to be placed on a partially completed pallet, wherein the modified item placement sequence changes an order in which items are added to the partially completed pallet.

At least a portion of the functionality of the various elements in FIG. 1, FIG. 2, FIG. 3, FIG. 4, FIG. 15, FIG. 16, and FIG. 17 may be performed by other elements in FIG. 1, FIG. 2, FIG. 3, FIG. 4, FIG. 15, FIG. 16, and FIG. 17, or an entity (e.g., processor, web service, server, application program, computing device, etc.) not shown in FIG. 20, FIG. 21, FIG. 22, and FIG. 23.

In some examples, the operations illustrated in FIG. 20, FIG. 21, FIG. 22, and FIG. 23 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for dynamic generation of pallet-build instructions. For example, the elements illustrated in FIG. 1, FIG. 2, FIG. 3, FIG. 4, FIG. 15, FIG. 16, FIG. 17, and FIG. 18, such as when encoded to perform the operations illustrated in FIG. 20, FIG. 21, FIG. 22, and FIG. 23, constitute exemplary means for generating a set of per-pallet build instructions for creating a proposed pallet including a selected set of items based on item data; exemplary means for analyzing user input and sensor data received from a set of sensors associated with a pallet-build area to identify item placement for each item in the selected set of items placed within a partially completed pallet; exemplary means for generating dynamic item location data for each item in the selected set of items placed on the partially completed pallet; exemplary means for dynamically modifying the item placement sequence; exemplary means for modifying a next assigned location of a next item to be placed on the partially completed pallet in the modified item placement sequence based on the dynamic item location data obtained from the verification component; exemplary means for optimizing pallet build in real-time as each item is placed; and exemplary means for outputting the dynamically modified next assigned location of the next item in the item placement sequence to a user device associated with the user.

In another example, the elements illustrated in FIG. 1, FIG. 2, FIG. 3, FIG. 4, FIG. 15, FIG. 16, FIG. 17, and FIG. 18, such as when encoded to perform the operations illustrated in FIG. 20, FIG. 21, FIG. 22, and FIG. 23, constitute exemplary means for generating a set of per-pallet build instructions for creating a proposed pallet including a selected set of items based on item data, the set of per-pallet build instructions comprising an item placement sequence and an assigned location for each item in the selected set of items; exemplary means for analyzing sensor data received from a set of sensors associated with a pallet-build area to identify item placement for each item placed within a partially completed pallet; exemplary means for generating dynamic item location data for each item from the selected set of items placed on the partially completed pallet; exemplary means for dynamically modifying the item placement sequence for a remaining set of items to be placed on the partially completed pallet based on the dynamic item location data; and exemplary means for outputting a next assigned location of a next item in the dynamically modified item placement sequence to a user device associated with the user.

In still another example, the elements illustrated in FIG. 1, FIG. 2, FIG. 3, FIG. 4, FIG. 15, FIG. 16, FIG. 17, and FIG. 18, such as when encoded to perform the operations illustrated in FIG. 20, FIG. 21, FIG. 22, and FIG. 23, constitute exemplary means for analyzing sensor data received from a set of sensors associated with a pallet-build area to identify item placement for each item placed within a partially completed pallet; constitute exemplary means for sending a temporary placement query requesting a temporary placement status of an incorrectly placed item to the user device in response to detecting an item placed at an incorrect placement location; constitute exemplary means for outputting an unmodified next placement location of a next item in an item placement sequence to the user device associated with the user in response to receiving the temporary placement status of the incorrectly placed item; and constitute exemplary means for outputting a dynamically modified next assigned location of the next item in the item placement sequence to the user device associated with the user in response to receiving a permanent placement status of the incorrectly placed item.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for customized pallet-build, the system comprising:
a memory;
at least one processor communicatively coupled to the memory;
an interactive pallet-build component, implemented on the at least one processor, that generates a set of per-pallet build instructions for creating a proposed pallet including a selected set of items based on item data, the set of per-pallet build instructions comprising an item placement sequence and an assigned location for each item in the selected set of items;
a verification component, implemented on the at least one processor, that analyzes user input and sensor data received from a set of sensors associated with a pallet-build area to identify item placement for each item in the selected set of items placed within a partially completed pallet and generate dynamic item location data for each item in the selected set of items placed on the partially completed pallet;
the interactive pallet-build component, implemented on the at least one processor, that dynamically modifies the item placement sequence and modifies a next assigned location of a next item to be placed on the partially completed pallet in the modified item placement sequence based on the dynamic item location data obtained from the verification component to optimize pallet build in real-time as each item is placed; and
a communications interface component, implemented on the at least one processor, that outputs the modified next assigned location of the next item in the item placement sequence to a user device associated with a user.

2. The system of claim 1, further comprising:
a selection component, implemented on the at least one processor, that selects a first set of items from a plurality of items for inclusion within a first proposed layer of a first pallet and selects a second set of items from the plurality of items for inclusion within a second proposed layer of the proposed pallet based on the item data, proposed pallet dimensions, a set of item stacking criteria, and a warehouse layout.

3. The system of claim 1, further comprising:
a customized warehouse layout generator, implemented on the at least one processor, that generates a warehouse layout for a plurality of items based on a set of weighted rules and the item data, the item data comprising at least one of an item weight, item size, item grouping, pick type, pick volume, pick time, item temperature, and stacking criteria associated with each item in the plurality of items.

4. The system of claim 1, further comprising:
a query component, implemented on the at least one processor, that outputs a query to the user device via the communications interface component, the query requesting a temporary placement status of an incorrectly placed item, wherein the interactive pallet-build component outputs an unmodified next assigned placement location for a next item in the item placement sequence in response to receiving the temporary placement status.

5. The system of claim 4, wherein the interactive pallet-build component outputs the modified next assigned placement location for the next item in the item placement sequence in response to receiving a permanent placement status.

6. The system of claim 1, wherein the interactive pallet-build component generates the modified item placement sequence based on dynamic item location data, a set of remaining items to be placed on the partially completed pallet, dimensions of available space in the partially completed pallet, and the item data, wherein the modified item placement sequence changes an order in which items are added to the partially completed pallet.

7. The system of claim 1, further comprising:
an alert component, implemented on the at least one processor, that outputs an alert to the user device identifying an incorrectly placed item and providing instructions for moving the incorrectly placed item to a correct assigned placement location or a modified location assignment.

8. The system of claim 1, wherein a placement location assigned to a given item comprises a pallet level, an assigned location within the pallet level, and an orientation of the item at the assigned location within the proposed pallet.

9. A computer-implemented method for customized pallet-build, the computer-implemented method comprising:
generating, by an interactive pallet-build component, a set of per-pallet build instructions for creating a proposed pallet including a selected set of items based on item data, the set of per-pallet build instructions comprising an item placement sequence and an assigned location for each item in the selected set of items;
analyzing, by a verification component, sensor data received from a set of sensors associated with a pallet-build area to identify item placement for each item placed within a partially completed pallet;
generating dynamic item location data for each item from the selected set of items placed on the partially completed pallet;
dynamically modifying, by the interactive pallet-build component, the item placement sequence for a remaining set of items to be placed on the partially completed pallet based on the dynamic item location data; and
outputting a next assigned location of a next item in the dynamically modified item placement sequence to a user device associated with a user.

10. The computer-implemented method of claim 9, further comprising:
generating a modified next assigned location of the next item in the dynamically modified item placement sequence to be placed on the partially completed pallet based on the dynamic item location data.

11. The computer-implemented method of claim 9, further comprising
dynamically generating a modified location assignment of at least one remaining item to be placed on the partially completed pallet, the modified location assignment comprising at least one of a new pallet level, a new location, and a new item orientation for the next item in the modified item placement sequence.

12. The computer-implemented method of claim 9, further comprising:
sending a query requesting a temporary placement status of an incorrectly placed item to the user device in response to detecting an item placed in an unassigned placement location.

13. The computer-implemented method of claim 9, further comprising:
sending a query requesting a temporary placement status of an incorrectly placed item to the user device in response to detecting an item placed in an incorrect orientation based on a current set of pallet-build instructions.

14. The computer-implemented method of claim 9, further comprising:
outputting an unmodified next assigned placement location for a next item in the item placement sequence in response to receiving a temporary placement status; and
outputting a dynamically modified next assigned placement location for the next item in the item placement sequence in response to receiving a permanent placement status.

15. The computer-implemented method of claim 9, further comprising:
generating a warehouse layout for a plurality of items based on a set of weighted rules and the item data, the item data comprising at least one of an item weight, item size, item grouping, pick type, pick volume, pick time, item temperature, and stacking criteria associated with each item in the plurality of items.

16. The computer-implemented method of claim 9, further comprising:
outputting an alert to the user device identifying an incorrectly placed item and providing instructions for moving the incorrectly placed item to a correct assigned placement location or a modified location assignment.

17. One or more computer storage media, having computer-executable instructions for customized pallet-build that, when executed by a computer cause the computer to perform operations comprising:
analyzing, by a verification component, sensor data received from a set of sensors associated with a pallet-build area to identify item placement for each item placed within a partially completed pallet;
sending a temporary placement query requesting a temporary placement status of an incorrectly placed item to a user device in response to detecting an item placed at an incorrect placement location;
outputting an unmodified next assigned location of a next item in an item placement sequence to the user device associated with a user in response to receiving the temporary placement status of the incorrectly placed item; and
outputting a dynamically modified next assigned location of the next item in the item placement sequence to the user device associated with the user in response to receiving a permanent placement status of the incorrectly placed item.

18. The one or more computer storage media of claim 17, wherein the computer-executable instructions for customized pallet-build further comprises:
outputting an alert to the user device identifying the incorrectly placed item and providing instructions for moving the incorrectly placed item to a correct assigned placement location or a modified location assignment for the incorrectly placed item.

19. The one or more computer storage media of claim 17, wherein the computer-executable instructions for customized pallet-build further comprises:
selecting a set of items from a plurality of items for inclusion within a first layer of a proposed pallet and selects a second set of items from the plurality of items for inclusion within a second layer of the proposed pallet on item data, dimensions of the proposed pallet, a set of item stacking criteria and a warehouse layout.

20. The one or more computer storage media of claim 17, wherein the computer-executable instructions for customized pallet-build further comprises:
generating a modified item placement sequence for a set of remaining items to be placed on a partially completed pallet, wherein the modified item placement sequence changes an order in which items are added to the partially completed pallet.
